(19) United States
(12) Patent Application Publication
(10) Pub. No.: US 2026/0233376 A1
(43) Pub. Date: Aug. 13, 2026

(54) POWER TOOL ATTACHMENT AND POWER TOOL

(71) Applicant: MAKITA CORPORATION, Anjo-shi (JP)

(72) Inventors: Takafumi KOTSUJI, Anjo-shi (JP); Tatsuya YASUDA, Anjo-shi (JP)

(73) Assignee: MAKITA CORPORATION, Anjo-shi (JP)

(21) Appl. No.: 19/533,659

(22) Filed: Feb. 9, 2026

(30) Foreign Application Priority Data
Feb. 13, 2025 (JP) 2025-021273
Nov. 5, 2025 (JP) 2025-186097

(51) Int. Cl. B25H 1/00; B25H 1/10

(52) U.S. Cl. CPC B25H 1/0042; B25H 1/10

(57) ABSTRACT

A power tool attachment includes an attachment member, a restricting member, and a coupling member. The attachment member is detachably attached to a power tool. The restricting member restricts relative movement of the power tool with respect to the object. The coupling member couples the restricting member and the attachment member. The attachment member includes (i) a shaft portion, and (ii) a stopper portion coupled to a tip end of the shaft portion and having a restricting surface orthogonal to a long axis of the shaft portion. The coupling member is configured to be able to couple the restricting member and the attachment member to cause the power tool attachment to be in a first state in which a long axis of the shaft portion and a drive axis of the tip tool are parallel to each other when the attachment member is attached to the power tool.

### CROSS-REFERENCE TO RELATED APPLICATION

The present application claims priority to Japanese Patent Application No. 2025-021273, filed on February 13, 2025; and Japanese Patent Application No. 2025-186097, filed on November 5, 2025. The contents of the foregoing applications are hereby fully incorporated herein by reference.

### TECHNICAL FIELD

The present disclosure relates to a power tool attachment and a power tool.

### BACKGROUND

In a power tool that machines a workpiece by driving a tip tool to oscillate around a drive axis, a power tool attachment is sometimes used that restricts a distance from an object, such as the workpiece, to the tip tool. For example, in EP 1857223, a power tool attachment is disclosed that includes a fixing portion for attaching the attachment to the power tool, and a stopper portion that comes into contact with an object and restricts the power tool from moving relative to the object.

### SUMMARY

In the known technology, a contact region at a tip end of the stopper portion has a circular columnar shape. Thus, when the stopper portion comes into contact with an object, there is a possibility that the stopper portion may roll with respect to the object and the power tool may rotate around the stopper portion.

Thus, there is a possibility that operation of the power tool may be unstable.

One non-limiting object of the present disclosure is to provide a power tool attachment with which a power tool can operate in a stable manner.

According to a non-limiting aspect of the present disclosure, a power tool attachment used in a power tool for machining a workpiece by driving a tip tool to oscillate around a drive axis is provided. The power tool attachment includes an attachment member, a restricting member, and a coupling member. The attachment member is detachably attached to the power tool. The restricting member is configured to come into contact with an object and restrict relative movement of the power tool with respect to the object. The coupling member is configured to couple the restricting member and the attachment member. The restricting member includes (i) a shaft portion, and (ii) a stopper portion coupled to a tip end of the shaft portion and having a restricting surface orthogonal to a long axis of the shaft portion. The coupling member is configured to be able to couple the restricting member and the attachment member to each other when the power tool attachment is in a first state, the first state being a state in which the long axis of the shaft portion and the drive axis of the tip tool are parallel to each other when the attachment member is attached to the power tool.

According to the power tool attachment according to the present aspect, in a direction parallel to the drive axis, a user can operate an oscillating tool in a stable manner while restricting a relative position of the oscillating tool with respect to the object to a position of the restricting surface.

According to another non-limiting aspect of the present disclosure, a power tool for machining a workpiece by driving a tip tool to oscillate around a drive axis is provided. The power tool includes a motor, a spindle, and the power tool attachment according to the above-described aspect. The spindle is configured to use power from the motor to drive the tip tool to oscillate around the drive axis.

According to the power tool according to the present aspect, in the direction parallel to the drive axis, the user can operate the oscillating tool in a stable manner while restricting the relative position of the oscillating tool with respect to the object to the position of the restricting surface.

### BRIEF DESCRIPTION OF THE DRAWINGS

FIG. 1 is an explanatory view showing an external configuration of an oscillating tool according to a first embodiment.

FIG. 2 is a cross-sectional view showing an internal configuration of the oscillating tool.

FIG. 3 is a cross-sectional view at a position III-III shown in FIG. 2.

FIG. 4 is an explanatory view showing an external configuration of an attachment according to the first embodiment.

FIG. 5 is a perspective view showing an external configuration of a restricting member.

FIG. 6 is a perspective view showing an external configuration of an attachment member.

FIG. 7 is a plan view showing a configuration of the attachment member.

FIG. 8 is a front view showing a configuration of the attachment member.

FIG. 9 is a cross-sectional view at a position IX-IX shown in FIG. 8.

FIG. 10 is an explanatory view showing a configuration of a circular cylindrical portion of the oscillating tool.

FIG. 11 is an explanatory view showing a configuration of the tubular member in a state in which the attachment member is attached.

FIG. 12 is a cross-sectional view at a position XII-XII shown in FIG. 2.

FIG. 13 is an explanatory view showing a configuration of an extending portion of the attachment member.

FIG. 14 is a cross-sectional view at a position XIV-XIV shown in FIG. 8.

FIG. 15 is a plan view showing an external configuration of a coupling member.

FIG. 16 is an explanatory view showing a configuration of a shaft insertion portion of the coupling member.

FIG. 17 is a cross-sectional view at a position XVII-XVII shown in FIG. 16.

FIG. 18 is an explanatory view showing the shaft insertion portion in a state in which a shaft portion of the restricting member is inserted.

FIG. 19 is an explanatory view showing a band attachment portion in a state of housing the extending portion.

FIG. 20 is an explanatory view at a position XX-XX shown in FIG. 19.

FIG. 21 is an explanatory view at a position XXI-XXI shown in FIG. 20.

FIG. 22 is an explanatory view showing the oscillating tool to which the attachment is attached in a first state.

FIG. 23 is an explanatory view showing an external configuration of the attachment in a second state.

FIG. 24 is an explanatory view showing the oscillating tool to which the attachment is attached in the second state.

FIG. 25 is an explanatory view showing an external configuration of an oscillating tool according to a second embodiment.

FIG. 26 is a cross-sectional view showing an internal configuration of the oscillating tool according to the second embodiment.

FIG. 27 is an explanatory view showing a configuration of an attachment according to the second embodiment.

FIG. 28 is a plan view showing an upper side configuration of the attachment according to the second embodiment.

FIG. 29 is an exploded perspective view showing a configuration of an attachment member.

FIG. 30 is a perspective view showing a configuration of the attachment member.

FIG. 31 is a cross-sectional view of a position XXXI-XXXI shown in FIG. 28.

FIG. 32 is a perspective view showing a configuration of a rectangular portion formed at a front end portion of a housing.

FIG. 33 is a plan view showing a configuration of a lower side of an attachment portion.

FIG. 34 is an explanatory view showing a method of attaching the attachment member to the rectangular portion.

FIG. 35 is a perspective view showing a configuration of an extending portion.

FIG. 36 is a cross-sectional view of a position XXXVI-XXXVI shown in FIG. 28.

FIG. 37 is a perspective view showing the oscillating tool to which the attachment member is attached directly in front of a drive axis.

FIG. 38 is a cross-sectional view of a position XXXVIII-XXXVIII shown in FIG. 35.

FIG. 39 is a perspective view showing the oscillating tool to which a restricting member is attached directly in front of the drive axis.

### DETAILED DESCRIPTION OF THE EMBODIMENTS

Hereinafter, representative and non-limiting specific examples of the present disclosure will be described in detail with reference to the drawings. This detailed description is simply intended to show, to a person skilled in the art, details for embodying a preferable example of the present disclosure, and is not intended to limit the scope of the present disclosure. Further, additional features and the disclosure disclosed below can be used separately or together with other features and disclosures, in order to provide a further improved device, and a manufacturing method and a usage method thereof.

Further, combinations of features and processes disclosed in the following detailed description are not essential, in broad terms, when embodying the present disclosure, and, in particular, are given for describing representative specific examples of the present disclosure. Furthermore, when presenting additional and effective embodiments of the present disclosure, various features of representative specific examples described above and below, and various features described in independent and dependent claims need not necessarily be combined as in the specific examples given here, or in a given order.

All features listed in the present specification and/or in the scope of the claims are intended to be disclosed separately, and independently of each other, as limitations to the disclosure at the time of filing and to the claimed specific items, separately to the configuration of features listed in the embodiments and/or in the scope of the claims. Furthermore, description relating to all numerical ranges and groups or collections are treated as intending to disclose intermediate configurations related thereto, as limitations to the disclosure at the time of filing and to the claimed specific items.

In a non-limiting embodiment of the present disclosure, the coupling member may include (i) an insertion portion, the shaft portion being insertable into the insertion portion, and (ii) a fixing portion configured to come into contact with the shaft portion inserted into the insertion portion and to be able to fix the shaft portion. The fixing portion may be configured to be able to come into contact at a plurality of positions of the shaft portion in an extending direction of the shaft portion. The coupling member may be configured for a distance from the coupling member to the stopper portion in the extending direction of the shaft portion to be adjustable by switching the position at which the fixing portion comes into contact with the shaft portion.

According to this embodiment, a user can adjust the position of a restricting surface with respect to the coupling member to a desired position along a long axis of the shaft portion.

In addition to the above-described embodiment, or in place of the above-described embodiment, the shaft portion may include a plurality of first engagement portions formed at a plurality of positions in the extending direction of the shaft portion. The fixing portion may include a second engagement portion engageable with each of the plurality of first engagement portions. The coupling member may be configured for the distance from the coupling member to the stopper portion in the extending direction of the shaft portion to be adjustable using the engagement between the second engagement portion and the plurality of first engagement portions.

According to this embodiment, the user can fix the position of the restricting surface with respect to the coupling member using a simple method of the engagement between the second engagement portion and the plurality of first engagement portions.

In addition to the above-described embodiment, or in place of the above-described embodiment, the insertion portion may be configured for the shaft portion to be insertable therein in a state of the shaft portion being rotated to a plurality of rotation angles around the long axis of the shaft portion.

According to this embodiment, the user can switch an orientation of the stopper portion coupled to the shaft portion to the plurality of rotation angles, with respect to the coupling member, around the long axis of the shaft portion.

In addition to the above-described embodiment, or in place of the above-described embodiment, the attachment member may include a clamp portion and a third engagement portion. The clamp portion is configured to be attached to the power tool to surround the drive axis. The third engagement portion extends from the clamp portion. The coupling member may include a fourth engagement portion. The fourth engagement portion is configured to be engageable with the third engagement portion that is in a state of being rotated to a plurality of rotation angles around a long axis of the third engagement portion. Using the engagement between the third engagement portion and the fourth engagement portion, the coupling member may be configured to be able to couple, to the attachment member, the restricting member rotated to the plurality of rotation angles around the long axis of the third engagement portion.

According to this embodiment, the user can adjust the extending direction of the shaft portion with respect to the drive axis to the plurality of rotation angles around the long axis of the third engagement portion.

In addition to the above-described embodiment, or in place of the above-described embodiment, using the engagement between the third engagement portion and the fourth engagement portion, the coupling member may be configured to be able to switch the power tool attachment between (i) the first state, and (ii) a second state in which, when the attachment member is attached to the power tool, the long axis of the shaft portion is orthogonal to the drive axis of the tip tool and to an extending direction of the third engagement portion.

According to this embodiment, the user can switch the arrangement of the restricting surface of the stopper portion to a desired position including a position lower than the tip tool and a position further to the front than the drive axis.

In addition to the above-described embodiment, or in place of the above-described embodiment, the third engagement portion may include (i) a base portion extending from the clamp portion, (ii) an angle determining portion coupled to a tip end of the base portion, and (iii) an engagement recess formed in the base portion. The fourth engagement portion may include (i) a housing portion able to house the angle determining portion rotated to a plurality of rotation angles around a long axis of the base portion, and (ii) an engagement protrusion configured to engage with the engagement recess and fix the angle determining portion housed in the housing portion.

According to this embodiment, the extending direction of the shaft portion with respect to the drive axis can be adjusted to the plurality of rotation angles around the long axis of the third engagement portion using a simple coupling structure.

In addition to the above-described embodiment, or in place of the above-described embodiment, the attachment member may include a clamp portion to be attached to the power tool to surround the drive axis. The clamp portion may be configured to be able to attach, to the power tool, the attachment member rotated to a plurality of rotation angles around the drive axis.

According to this embodiment, the user can adjust the arrangement of the coupling member to the plurality of rotation angles around the drive axis.

In addition to the above-described embodiment, or in place of the above-described embodiment, the clamp portion may include a plurality of sixth engagement portions engageable with a fifth engagement portion formed in the power tool. The plurality of sixth engagement portions may be formed at a plurality of positions corresponding to the plurality of rotation angles around the drive axis. The clamp portion may be configured to be able to attach, to the power tool, the attachment member rotated to the plurality of rotation angles around the drive axis, by engaging the fifth engagement portion with one of the plurality of sixth engagement portions formed at the plurality of positions.

According to this embodiment, the user can fix the arrangement of the coupling member to the plurality of rotation angles around the drive axis using a simple method of the engagement between the fifth engagement portion and the plurality of sixth engagement portions.

In addition to the above-described embodiment, or in place of the above-described embodiment, the clamp portion may include a first main body and a second main body disposed facing each other and able to clamp the power tool to surround the drive axis. The attachment member may include a distance adjustment portion configured to be able to adjust a separation distance between the first main body and the second main body.

According to this embodiment, the user can attach, detach, or rotate the attachment member with respect to a circular cylindrical portion without using a dedicated tool.

In addition to the above-described embodiment, or in place of the above-described embodiment, the fifth engagement portion may be a protrusion protruding from an outer surface of the power tool by a predetermined distance. The attachment member may be configured to be able to adjust the separation distance by an amount equal to or greater than the distance by which the protrusion protrudes from the outer surface of the power tool.

According to this embodiment, the user can attach, detach, or rotate the attachment member with respect to the circular cylindrical portion using a simple method of using the distance adjustment portion to adjust the separation distance between the first main body and the second main body by an amount equal to or greater than the distance by which the protrusion protrudes. Further, by adjusting the separation distance by the amount roughly corresponding to the distance by which the protrusion protrudes, the user can rotate the clamp portion around the drive axis while suppressing or preventing the attachment member from falling off from the circular cylindrical portion.

### First Embodiment

### Overall Configuration of Oscillating Tool 100

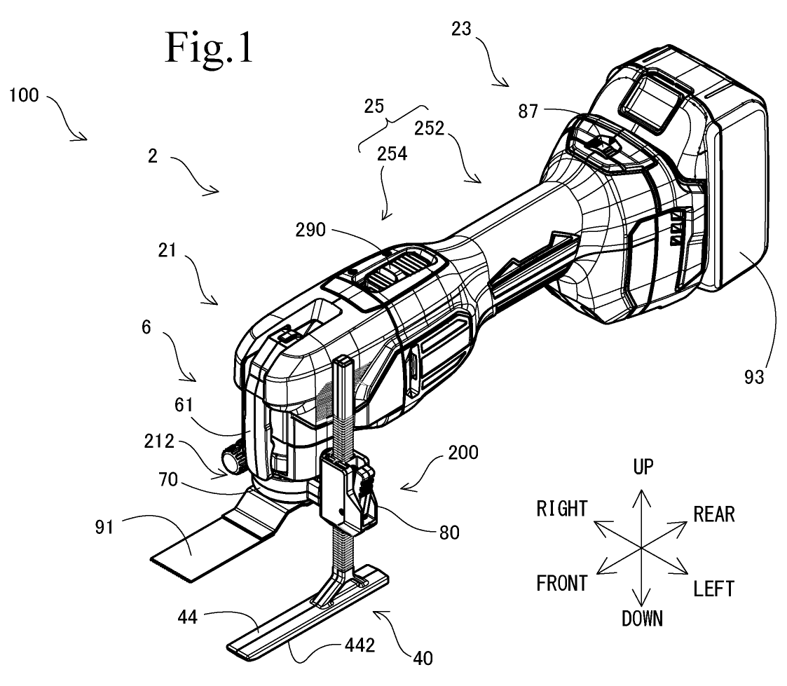

Hereinafter, an overall configuration of an oscillating tool 100 according to a first embodiment will be described with reference to the drawings. As shown in FIG. 1, the oscillating tool 100 is an example of a power tool that drives a tip tool 91 to oscillate and performs a machining operation on a workpiece (not shown in the drawings). The tip tool 91 is a blade, a scraper, a grinding pad, a polishing pad, or the like, for example. A user can select one of these tip tools 91 suitable for a desired machining operation, such as cutting, peeling, grinding, polishing, or the like, attach the selected tip tool 91 to the oscillating tool 100, and perform the machining operation. Note that, in the present embodiment, the description uses an example in which the blade is attached to the oscillating tool 100 as the tip tool 91.

As shown in FIG. 1, an attachment 200 is detachably attached to the oscillating tool 100. The attachment 200 comes into contact with an object, such as the workpiece, and restricts the relative movement of the oscillating tool 100 with respect to the object. Note that, in addition to the workpiece, the object also includes an object other than the workpiece, such as a wall in the vicinity of the workpiece, for example.

### Configuration of Housing 2

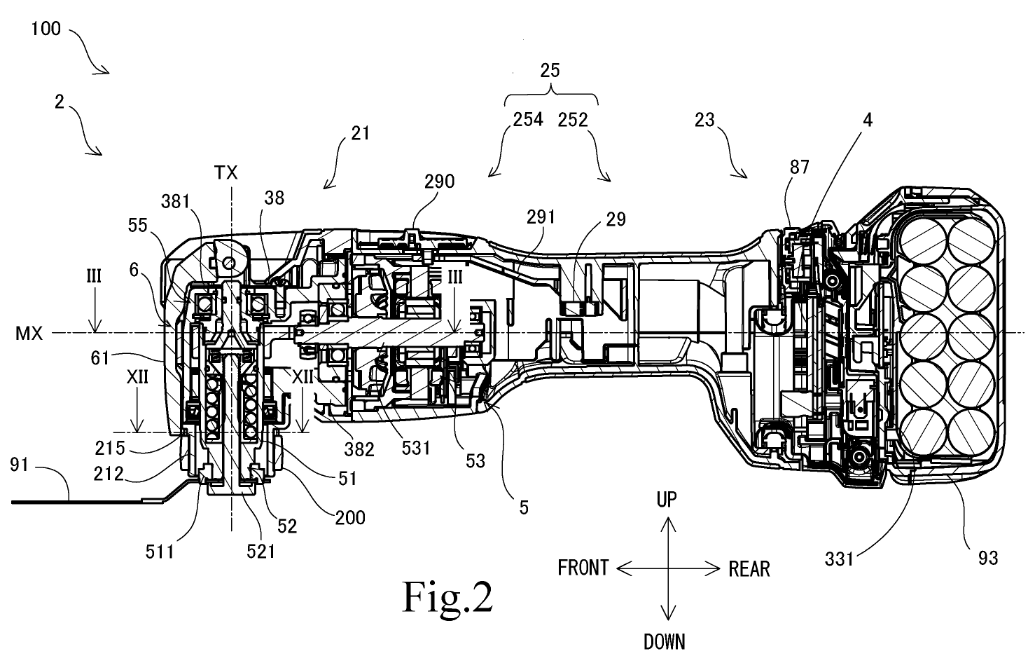

As shown in FIG. 1 and FIG. 2, the oscillating tool 100 includes a housing 2 having a long shape. The housing 2 forms an outer contour of the oscillating tool 100.

As shown in FIG. 2, the housing 2 houses a spindle 51, a motor 53, and the like. The motor 53 is disposed such that a rotation axis MX of an output shaft 531 extends in parallel to the extending direction of the housing 2. A drive axis TX of the spindle 51 is disposed to be orthogonal to the extending direction of the housing 1. One end portion of the spindle 51 protrudes from the housing 2 in the drive axis TX direction, and is exposed to the outside. The tip tool 91 can be detachably attached to the protruding section of the spindle 51. A battery 93 that can supply power to the motor 53 is detachably attached to another end in the extending direction of the housing 2. The oscillating tool 100 is configured to cause the tip tool 91 to oscillate in an oscillation plane orthogonal to the drive axis TX, by causing the spindle 51 to reciprocate and rotate, using the power of the motor 53, within a predetermined angle range around the drive axis TX.

In the following description, as necessary, in relation to directions of the oscillating tool 100, an extending direction of the drive axis TX of the spindle 51 is defined as the up-down direction, the one end side of the spindle 51 to which the tip tool 91 is attached is defined as the lower side, and the opposite side is defined as the upper side. Further, the direction corresponding to the rotation axis MX of the output shaft 531 is defined as the front-rear direction, one end side of the housing 2 in which the spindle 51 is housed is defined as the front side, and the opposite end side to which the battery 93 is attached is defined as the rear side. A direction orthogonal to the up-down direction and the front-rear direction is defined as the left-right direction. When the blade shown in the drawings as the tip tool 91 is attached, an oscillation direction of the tip tool 91 roughly corresponds to the left-right direction.

As shown in FIG. 1, in the present embodiment, the housing 2 includes a front end portion 21, a rear end portion 23, and a central portion 25 connecting the front end portion 21 and the rear end portion 23.

As shown in FIG. 2, the front-end portion 21 has a substantially circular cylindrical shape extending in the up-down direction. The front-end portion 21 houses a metal housing 38. An operation lever 61, which operates a lock mechanism 6, is provided at the front-end portion 21. A circular cylindrical portion 212 extending along the drive axis TX is formed at the lower front-end portion of the front-end portion 21. The circular cylindrical portion 212 houses the lower end portion of the spindle 51. An engagement protrusion 215 to be described later is formed on the circular cylindrical portion 212.

The metal housing 38 has a substantially L shape including a first section 381 extending in the up-down direction, and a second section 382 extending in the front-rear direction. The first section 381 houses the spindle 51. The second section 382 houses a transmission mechanism 55 to be described later. Further, the second section 382 houses the front end of the output shaft 531 of the motor 53, and functions as a part of a motor housing 254.

The lock mechanism 6 is configured to be able to lock a clamp shaft 52 at a clamped position at which the tip tool 91 can be clamped between the clamp shaft 52 and the spindle 51. The clamp shaft 52 is a member having a substantially circular columnar shape and, is long in the up-down direction. The clamp shaft 52 is inserted into the spindle 51 coaxially with the spindle 51. A clamp head 521 is formed at the lower end portion of the clamp shaft 52.

When the operation lever 61 is disposed at a lock position, the tip tool 91 is clamped between a tool attachment portion 511 and the clamp head 521 and, is fixed to the spindle 51. When the operation lever 61 is disposed at a lock release position, the locking of the clamp shaft 52 is released. The user can remove the clamp shaft 52 from the spindle 51 and can attach or detach the tip tool 91.

The central portion 25 is formed between the front-end portion 21 and the rear end portion 23. The central portion 25 includes the motor housing 254, and a grip portion 252 connected to the rear end of the motor housing 254.

The grip portion 252 is configured to be grippable by the user. The grip portion 252 is formed in a cylindrical shape having a roughly uniform diameter, and extends in a straight line in the front-rear direction. The grip portion 252 is formed to be narrower than the front-end portion 21 and the rear end portion 23, in order to be more easily gripped by the user. The grip portion 252 houses a lead wire for electrically connecting the motor 53 and a controller 4, a switch 29, and the like.

The motor housing 254 houses the motor 53. In the present embodiment, the motor 53 is housed in the motor housing 254 such that the rotation axis MX of the output shaft 531 of the motor 53 is orthogonal to the drive axis TX of the spindle 51. Thus, the front-end portion 21 of the housing 2 is downsized, compared to a case in which the motor 53 is housed such that the rotation axis MX is parallel to the drive axis TX. A switch knob 290 configured to be manually operable by the user is provided on the upper surface of the motor housing 254.

The switch knob 290 is configured to be able to slide in the front-rear direction by a manual operation. A switch lever 291 that extends in the front-rear direction is coupled to the switch knob 290. The switch lever 291 moves between an on position and an off position in accordance with the operation of the switch knob 290, and switches the switch 29 on and off. The switch 29 is a so-called microswitch. The driving of the motor 53 is started in accordance with the switch 29 being turned on.

The rear end portion 23 is formed in a cylindrical shape whose diameter increases toward the rear. In other words, the rear end portion 23 is formed such that the outer shape of a cross-section thereof orthogonal to the rotation axis MX becomes larger the further toward the rear. The rear end portion 23 includes a battery attachment portion 331 with which the battery 93 can be slidingly engaged.

A power receiving terminal and the like that can be electrically connected to a power supply terminal of the battery 93 is provided in the battery attachment portion 331. At the upper end portion of the rear end portion 23, a dial 87 is held in a state in which an upper side section of the dial 87 is exposed to the outside. The dial 87 is configured as an operation device that receives a rotation operation by the user, and sets a rotational speed of the motor 53 in a stepless manner.

The controller 4 is housed in the rear end portion 23. The controller 4 includes a circuit board on which are mounted a CPU as a processor controlling driving of the motor 53, storage devices such as a RAM, a ROM, and the like, and switching terminals and the like that operate based on control signals from the CPU. The controller 4 starts the driving of the motor 53 in accordance with the switch 29 being turned on. The controller 4 can further set the rotation speed of the motor 53 based on a resistance value set via the dial 87.

### Configuration of Drive Mechanism 5

As shown in FIG. 2, a drive mechanism 5 is provided in the front-end portion 21 of the housing 2 and the motor housing 254 of the central portion 25. The drive mechanism 5 is a mechanism for driving the tip tool 91 to oscillate. The drive mechanism 5 includes the spindle 51, the motor 53, and the transmission mechanism 55.

The spindle 51 is a long member having a substantially circular cylindrical shape. In the present embodiment, the spindle 51 is housed in the metal housing 38 and is supported by two bearings to be rotatable around the drive axis TX. At the lower end portion of the spindle 51 exposed to the outside from the housing 2, the spindle 51 includes the tool attachment portion 511 that is configured for the tip tool 91 to be detachably attached thereto. In the present embodiment, the tip tool 91 is clamped between the tool attachment portion 511 and the clamp head 521 of the clamp shaft 52.

The motor 53 is a brushless DC motor, and includes a stator, a rotor disposed on an inner side of the stator in the radial direction, and the output shaft 531 that rotates integrally with the rotor. The rotation axis MX of the output shaft 531 of the motor 53 is orthogonal to the drive axis TX of the spindle 51 and extends in parallel to the front-rear direction and the extending direction of the housing 2.

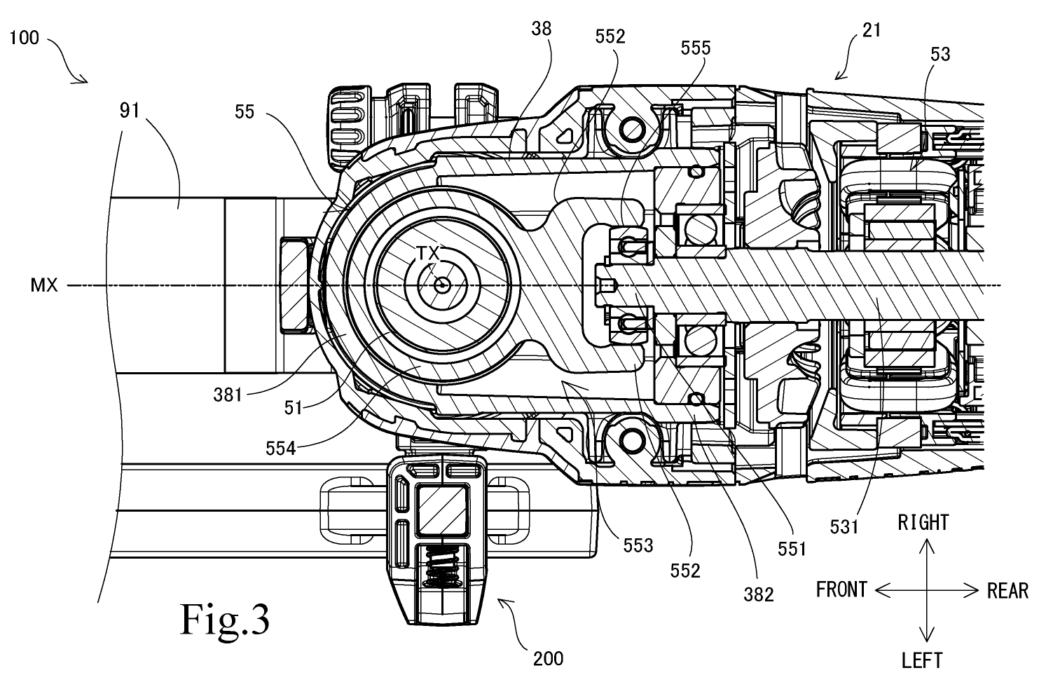

As shown in FIG. 3, the transmission mechanism 55 is disposed over the first section 381 and the second section 382 of the metal housing 38. The transmission mechanism 55 is configured to transmit a rotational movement of the motor 53 to the spindle 51, and to cause the spindle 51 to reciprocate and rotate within the predetermined angle range around the drive axis TX. The transmission mechanism 55 includes an eccentric shaft 551, a coupling arm 553, and a drive bearing 555.

The eccentric shaft 551 is connected to the front end of the output shaft 531 of the motor 53. The eccentric shaft 551 extends toward the front from the front end of the output shaft 531, at a position offset to the outer side in the radial direction from the rotation axis MX. As a result of the rotation of the output shaft 531, the eccentric shaft 551 rotates around the rotation axis MX at the position offset to the outer side in the radial direction from the rotation axis MX.

The drive bearing 555 is attached to an outer peripheral portion of the eccentric shaft 551. The outer peripheral surface of the drive bearing 555 has a curved surface shape, with a central section in the front-rear direction that bulges toward the outer side in the radial direction. The drive bearing 555 is also referred to as a sphere bearing.

The coupling arm 553 is a member that couples the drive bearing 555 and the spindle 51. Specifically, one end of the coupling arm 553 is fixed to the spindle 51, and the other end is connected to the eccentric shaft 551. The coupling arm 553 reciprocates and rotates with the spindle 51 as a fulcrum, as a result of the rotational movement of the eccentric shaft 551.

An annular portion 554 is formed in an annular shape at the front end of the coupling arm 553, and a pair of arm portions 552 are formed at the rear end of the coupling arm 553. The annular portion 554 is fixed to the outer periphery of the upper end portion of the spindle 51. The pair of arm portions 552 are disposed so as to be in contact with outer peripheral portions of the drive bearing 555. The coupling arm 553 is coupled to the eccentric shaft 551 as a result of the pair of arm portions 552 clamping the drive bearing 555 in the left-right direction.

When the motor 53 is driven, the eccentric shaft 551 rotates integrally with the output shaft 531. When the eccentric shaft 551 rotates around the rotation axis MX, the drive bearing 555 also moves around the rotation axis MX. In the eccentric rotation movement of the eccentric shaft 551, the eccentric shaft 551 reciprocates in the left-right direction with respect to the rotation axis MX. Due to the reciprocating movement of the eccentric shaft 551 in the left-right direction, the pair of arm portions 552 of the coupling arm 553 rotate while oscillating in the left-right direction.

The oscillation of the pair of arm portions 552 in the left-right direction is transmitted to the spindle 51 via the annular portion 554, and the spindle 51 reciprocates and rotates in the peripheral direction around the drive axis TX. As a result, the tip tool 91 fixed to the tool attachment portion 511 of the spindle 51 oscillates around the drive axis TX. By pressing the tip tool 91 against the workpiece, the user can perform the machining operation by the oscillating tool 100.

### External Configuration of Attachment 200

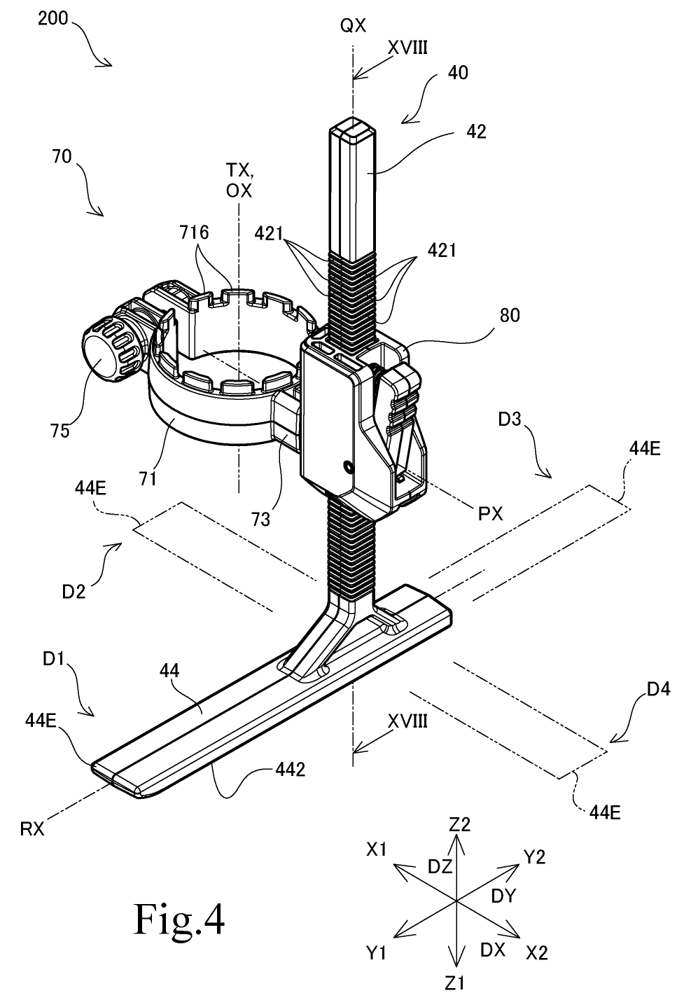

As shown in FIG. 4, the attachment 200 includes an attachment member 70, a restricting member 40, and a coupling member 80 that rotatably couples the attachment member 70 and the restricting member 40. The attachment 200 is detachably attached to the oscillating tool 100 using the attachment member 70. With the attachment 200 attached to the oscillating tool 100, relative movement of the oscillating tool 100 with respect to an object is restricted by the restricting member 40.

### Configuration of Restricting Member 40

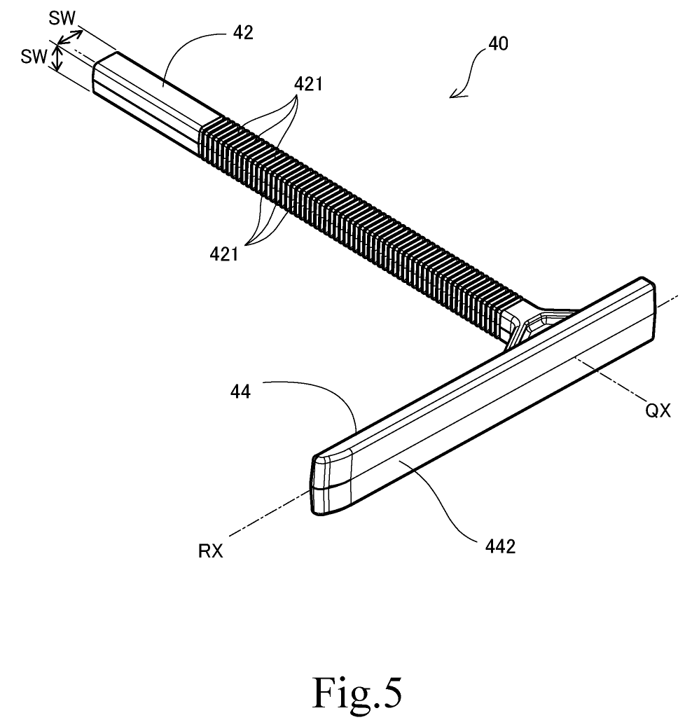

As shown in FIG. 5, the restricting member 40 comes into contact with the object and restricts the relative movement of the oscillating tool 100 with respect to the object. The restricting member 40 includes a shaft portion 42 and a stopper portion 44.

The shaft portion 42 is a long member extending in a straight line. In the present embodiment, the shaft portion 42 has a substantially square columnar shape. In a cross-section perpendicular to a long axis QX, a cross-sectional shape of the shaft portion 42 is a substantially square shape having widths SW. A plurality of teeth 421 are formed in each of side surfaces around the long axis QX of the shaft portion 42.

The plurality of teeth 421 are arrayed along the long axis QX. The plurality of teeth 421 are part of a ratchet mechanism to be described later and are used in adjustment of a distance from the coupling member 80 to the stopper portion 44.

The stopper portion 44 is coupled to the tip end of the shaft portion 42. The stopper portion 44 has a substantially cuboid shape extending in a direction orthogonal to the long axis QX. Of the stopper portion 44, a substantially flat restricting surface 442 is formed at the opposite side to the shaft portion 42, with a long axis RX of the stopper portion 44 interposed therebetween. The restricting surface 442 has a substantially long rectangular shape and is orthogonal to the long axis QX. The restricting surface 442 restricts relative movement of the attachment 200 with respect to the object, by coming into contact with the object. As a result, the relative movement of the oscillating tool 100 with respect to the object is restricted to a position of the restricting surface 442. Thus, the attachment 200 can restrict the object from coming closer to the oscillating tool 100 than the restricting surface 442. Since the restricting surface 442 has the flat and comparatively large surface area, the user can cause the restricting surface 442 to be in surface contact with the object and can operate the oscillating tool 100 in a stable manner while maintaining the contact between the restricting surface 442 and the object.

### Configuration of Attachment Member 70

### Configuration of Clamp Portion 71 and Distance Adjustment Portion 75

As shown in FIG. 1, the attachment member 70 is detachably attached to the oscillating tool 100. In the present embodiment, the attachment member 70 is attached to the circular cylindrical portion 212 of the housing 2 so as to surround the drive axis TX. By attaching the attachment member 70 to the circular cylindrical portion 212, the attachment 200 is fixed in the vicinity of the tip tool 91.

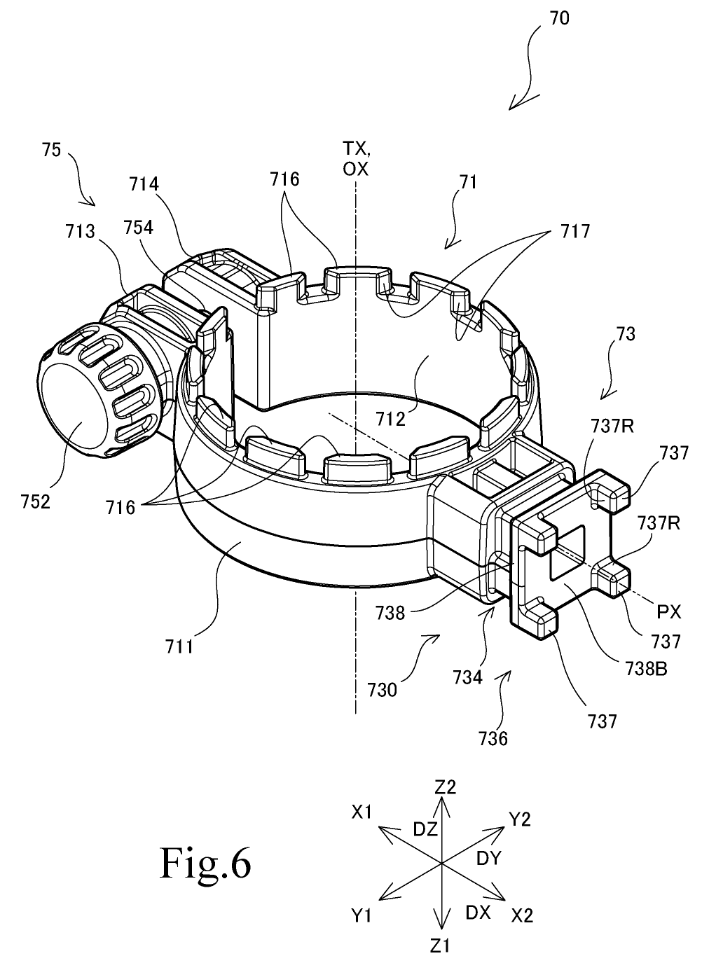

As shown in FIG. 6, the attachment member 70 is a band-shaped member formed of a resin material. The attachment member 70 includes a clamp portion 71 having a substantially circular cylindrical shape, an extending portion 73 extending from the clamp portion 71 in a first direction, and a distance adjustment portion 75. The clamp portion 71 surrounds a long axis OX and has a substantially circular cylindrical shape that is short in an axis direction.

The clamp portion 71 is attached to the circular cylindrical portion 212 of the oscillating tool 100 such that the long axis OX is substantially aligned with the drive axis TX of the spindle 51. In the example shown in FIG. 1, the attachment member 70 is attached to the oscillating tool 100 such that the long axis QX of the shaft portion 42 is parallel to the drive axis TX of the tip tool 91. The attachment 200 in this state is also referred to as being in a “first state”.

In the following description, as necessary, in relation to directions of the attachment 200, a direction corresponding to the long axis OX of the clamp portion 71 is defined as a first direction DZ. As shown in FIG. 1, when the attachment member 70 of the attachment 200 is attached to the oscillating tool 100, a side at which the tip tool 91 is disposed with respect to the attachment member 70 of the attachment 200 is defined as a first direction first side Z1, and the opposite side is defined as a first direction second side Z2. Further, the extending direction of the extending portion 73 (a direction corresponding to a long axis PX) is defined as a second direction DX. A side at which the clamp portion 71 is disposed with respect to the extending portion 73 is defined as a second direction first side X1, and the opposite side (the side on which the coupling member 80 is disposed) is defined as a second direction second side X2. A direction orthogonal to the first direction DZ and to the second direction DX is defined as a third direction DY. As shown in FIG. 1, when the attachment 200 is attached to the oscillating tool 100, a side at which the grip portion 252 is disposed with respect to the attachment 200 is defined as a third direction second side Y2, and the opposite side is defined as a third direction first side Y1.

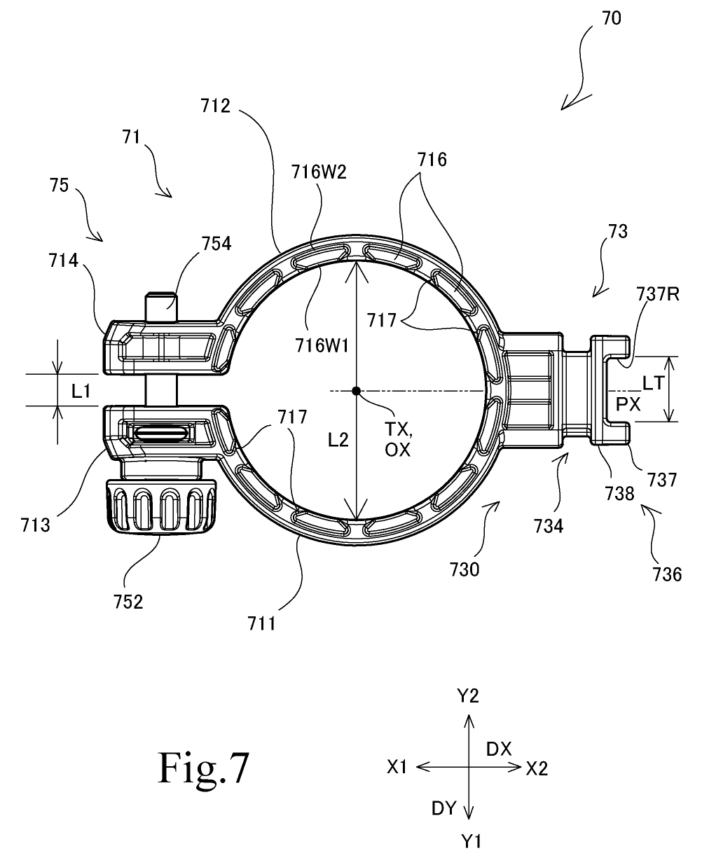

As shown in FIG. 6, the clamp portion 71 includes a first main body 711 disposed on a third direction first side Y1 and a second main body 712 disposed on the third direction second side Y2 with respect to each other, with the long axis PX interposed therebetween. As shown in FIG. 7, when the attachment member 70 is viewed along the first direction DZ, each of the first main body 711 and the second main body 712 has a substantially circular arc shape. The first main body 711 and the second main body 712 are disposed facing each other on either side of the drive axis TX (the long axis OX) and form the clamp portion 71 having the substantially circular cylindrical shape. The first main body 711 and the second main body 712 have elasticity, and a separation distance L2 between the first main body 711 and the second main body 712 can be adjusted using that elasticity.

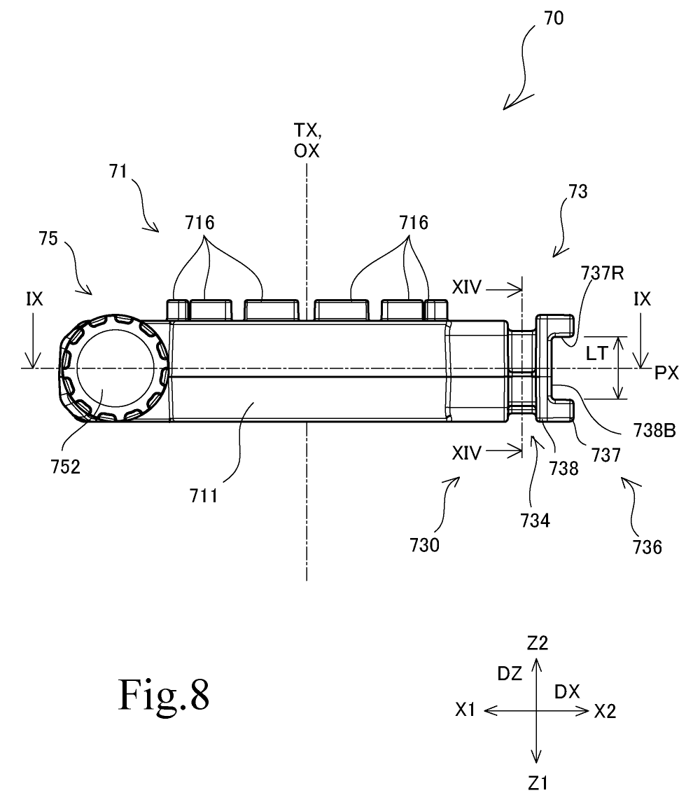

As shown in FIG. 6 to FIG. 8, a plurality of protruding walls 716 that extend toward the first direction second side Z2 are formed at end portions on the first direction second side Z2 of the first main body 711 and the second main body 712. As shown in FIG. 7, when the clamp portion 71 is viewed along the first direction DZ, the protruding walls 716 are arrayed at substantially equal intervals from each other in a peripheral direction around the long axis OX. In a radial direction centering on the long axis OX, each of the protruding walls 716 has a substantially trapezoid shape in which a width of an inner surface 716W1 on the inner side in the radial direction is smaller than a width of an outer surface 716W2 on the outer side in the radial direction. By adopting this type of configuration, between the adjacent protruding walls 716, a recess 717 is defined that has a substantially tapered shape whose width becomes narrower toward the outer side in the radial direction. In the present embodiment, a configuration is adopted in which the number of the protruding walls 716 is twelve, and a number of the recesses 717 is also twelve. Positions of the recesses 717 correspond to a rotation angle around the drive axis TX of the clamp portion 71 that can be adjusted with respect to the circular cylindrical portion 212 of the oscillating tool 100.

As shown in FIG. 7, the end portion of the first main body 711 on the second direction second side X2 and the end portion of the second main body 712 on the second direction second side X2 are coupled to each other. The end portion of the first main body 711 on the second direction first side X1 and the end portion of the second main body 712 on the second direction first side X1 are not coupled to each other. A first protruding portion 713 that extends toward the second direction first side X1 is formed on the end portion of the first main body 711 on the second direction first side X1. A second protruding portion 714 that extends toward the second direction first side X1 is formed on the end portion of the second main body 712 on the second direction first side X1. The first protruding portion 713 and the second protruding portion 714 function as part of the distance adjustment portion 75.

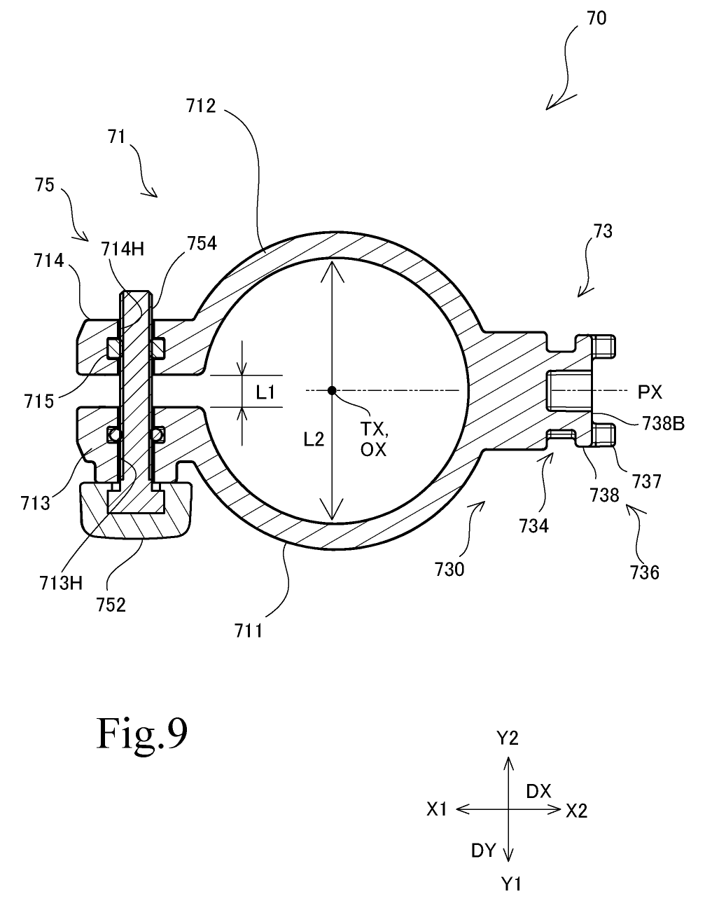

As shown in FIG. 7, the distance adjustment portion 75 includes the first protruding portion 713, the second protruding portion 714, a shaft portion 754, and a dial 752. The shaft portion 754 is a so-called bolt. As shown in FIG. 9, the shaft portion 754 is inserted through a through hole 713H formed in the first protruding portion 713 and a through hole 714H formed in the second protruding portion 714, and extends in the third direction DY. One end of the shaft portion 754 is coupled to the dial 752, and the shaft portion 754 rotates with respect to the first protruding portion 713 and the second protruding portion 714 in accordance with rotation of the dial 752.

A nut 715 is housed in the through hole 714H so as to be non-rotatable with respect to the second protruding portion 714. The nut 715 is engaged with a male screw formed at the shaft portion 754. Thus, when the dial 752 is rotated in the clockwise direction, the shaft portion 754 rotates with respect to the nut 715, and the nut 715 moves along the shaft portion 754. As a result, the second protruding portion 714 moves toward the first protruding portion 713 in accordance with the movement of the nut 715 with respect to the shaft portion 754. When the dial 752 is rotated in the counterclockwise direction, the first protruding portion 713 moves so as to separate from the second protruding portion 714.

By adopting this type of configuration, by a rotation operation of the dial 752, the user can adjust a separation distance L1 between the first protruding portion 713 and the second protruding portion 714 in the third direction DY in a stepless manner. Further, through the adjustment of the separation distance L1, the user can adjust the separation distance L2 between the first main body 711 and the second main body 712 in the third direction DY. Thus, by the operation of the dial 752, the user can adjust a degree of tightening and loosening of the attachment member 70 with respect to the circular cylindrical portion 212 of the oscillating tool 100, without using a dedicated tool. Further, the user can attach and detach the attachment member 70 to and from the circular cylindrical portion 212 using the simple method of operating the dial 752.

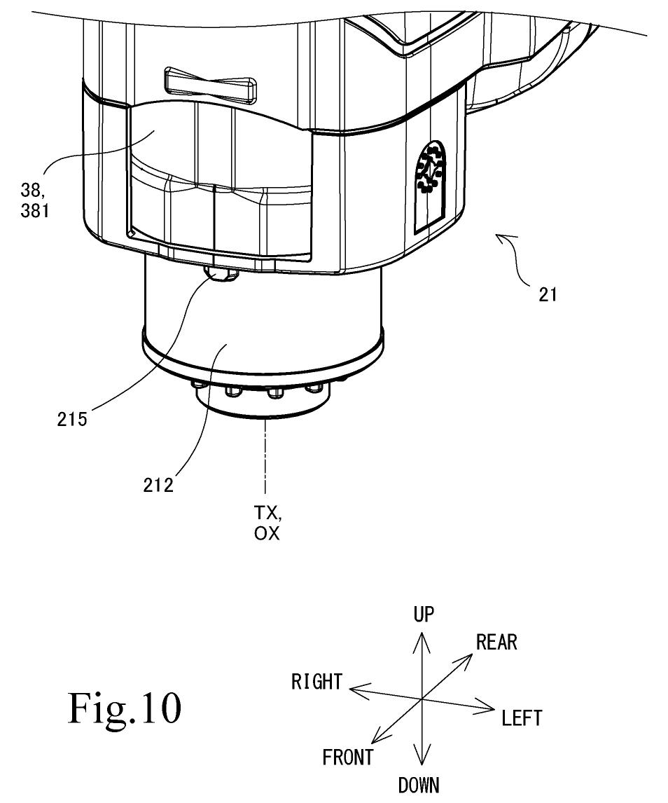

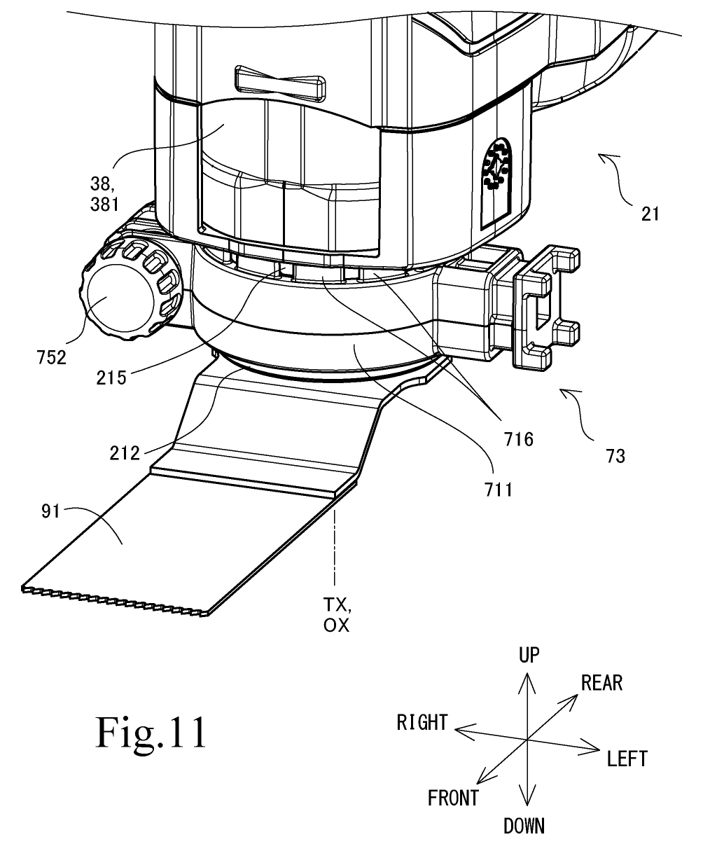

As shown in FIG. 10, the engagement protrusion 215 that protrudes to the front from the circular cylindrical portion 212 is formed at the upper end and the front end of the circular cylindrical portion 212 of the housing 2. In the clamp portion 71, the engagement protrusion 215 has a substantially trapezoid shape that corresponds to the recess 717 defined between the mutually adjacent protruding walls 716. Note that in FIG. 10, and in FIG. 11 to be described below, in order to facilitate understanding of the technology, the operation lever 61 is not shown. Further, in FIG. 10, the oscillating tool 100 is shown in a state in which the tip tool 91 is removed.

When the attachment member 70 is attached to the circular cylindrical portion 212, the user rotates the dial 752 in the counterclockwise direction and separates the first protruding portion 713 and the second protruding portion 714. For example, the user adjusts the separation distance L2 between the first main body 711 and the second main body 712 to be longer than a diameter of the circular cylindrical portion 212. The user disposes the first main body 711 and the second main body 712 so as to surround the drive axis TX, around the circular cylindrical portion 212 of the oscillating tool 100. At this time, the protruding walls 716 and the recesses 717 are disposed at the upper side. The user rotates the dial 752 in the clockwise direction, and as shown in FIG. 11, clamps the circular cylindrical portion 212 with the first main body 711 and the second main body 712, thus fixing the attachment member 70 to the circular cylindrical portion 212.

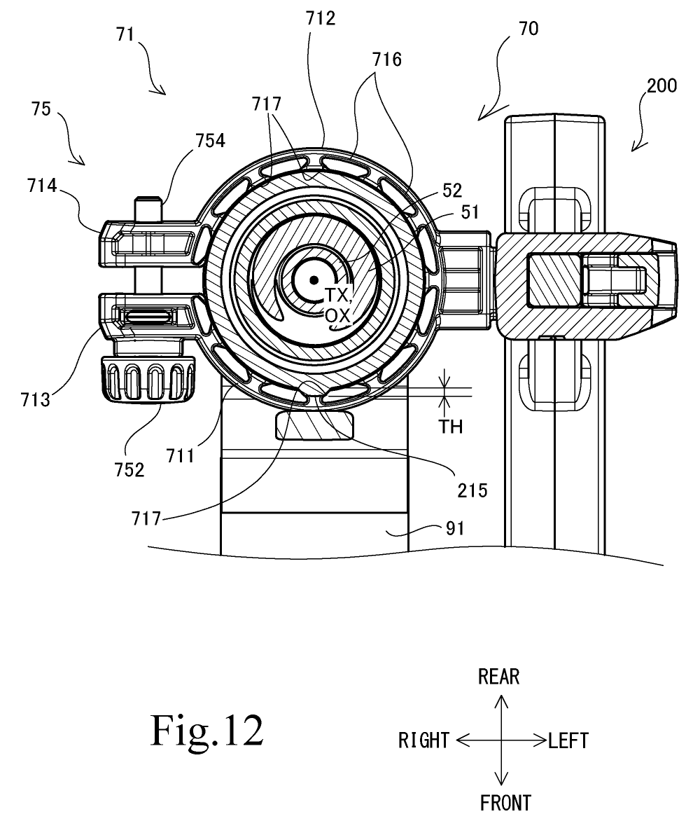

As shown in FIG. 12, by disposing the engagement protrusion 215 in the recess 717 at a desired position, of the plurality of recesses 717, the user can attach the attachment member 70 to the circular cylindrical portion 212 such that the attachment member 70 is at a desired rotational angle around the drive axis TX. In the present embodiment, as described above, the plurality of recesses 717 are disposed at the equal intervals at the twelve locations in the peripheral direction centering on the long axis OX. By adopting this type of configuration, the user can adjust the rotational angle of the attachment member 70 at 30 degree intervals around the long axis OX (the drive axis TX).

In the attachment 200 according to the present embodiment, after the attachment member 70 is fixed to the circular cylindrical portion 212, by rotating the dial 752 and slightly separating the first main body 711 and the second main body 712, the user can rotate the attachment member 70 around the drive axis TX without removing the attachment member 70 from the circular cylindrical portion 212.

As shown in FIG. 12, a thickness TH of the engagement protrusion 215 in the radial direction centering on the long axis OX is a thickness TH. The user operates the dial 752, such that the separation distance L2 (refer to FIG. 7) between the first main body 711 and the second main body 712 extends by an amount equal to or greater than the thickness TH. As a result, the engagement between the engagement protrusion 215 and the recess 717 can be released. Thus, the user can rotate the clamp portion 71 around the drive axis TX while suppressing or preventing the attachment member 70 from falling off from the circular cylindrical portion 212.

In the present embodiment, the protruding walls 716 and the recesses 717 have the trapezoid shape, and the engagement protrusion 215 has the trapezoid shape. Thus, when rotating the clamp portion 71 with respect to the circular cylindrical portion 212, inclined surfaces of the engagement protrusion 215 come into contact with inclined surfaces of the protruding walls 716. As a result, it is possible to suppress or prevent the engagement protrusion 215 and the protruding walls 716 from becoming caught on each other at the time of rotation. Thus, the user can rotate the clamp portion 71 with respect to the engagement protrusion 215 with a smaller amount of force compared to when the shape of the protruding walls 716 and the shape of the engagement protrusion 215 are rectangular.

### Configuration of Extending Portion 73

As shown in FIG. 4, the extending portion 73 couples the attachment member 70 to the coupling member 80. As shown in FIG. 6 to FIG. 8, the extending portion 73 includes a base portion 730, a recess 734, and an angle determining portion 736. The base portion 730 extends from the clamp portion 71 toward the second direction second side X2 along the long axis PX.

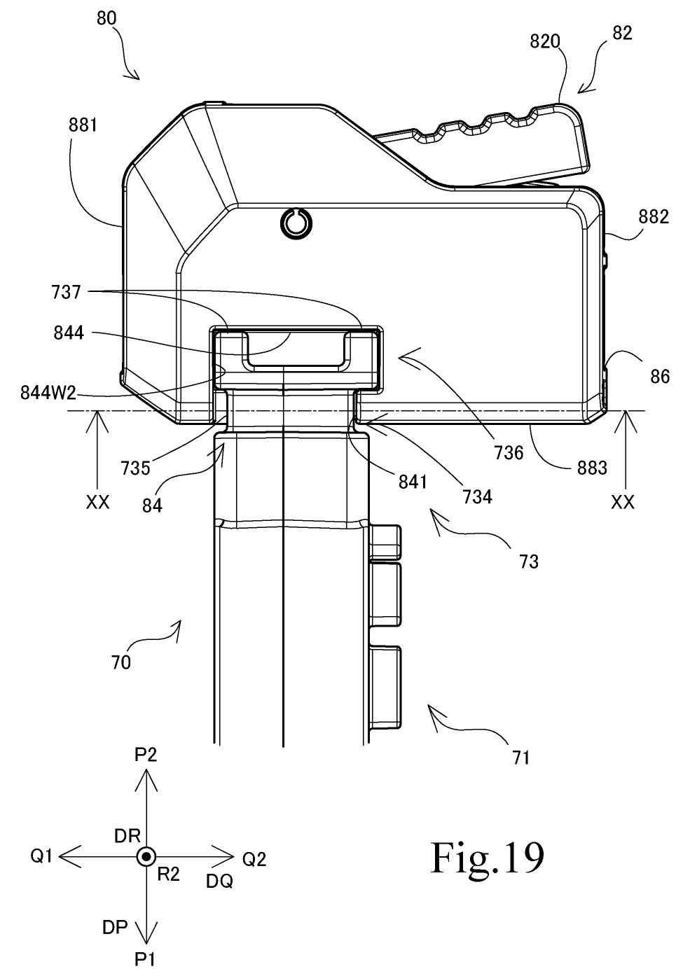

As shown in FIG. 6, the recess 734 is formed in the base portion 730. In the present embodiment, the recess 734 is a groove formed over the whole periphery of the base portion 730 around the long axis PX. The recess 734 is formed to be adjacent to the angle determining portion 736. As will be described below, the recess 734 can engage with a first restricting portion 841 and a second restricting portion 842 which are formed in a protruding shape on the coupling member 80 (refer to FIG. 19).

The angle determining portion 736 is coupled to the tip end of the base portion 730. The angle determining portion 736 is configured to be able to be housed in a housing portion 844 formed in the coupling member 80 (refer to FIG. 19). The angle determining portion 736 includes a plate 738, and a plurality of protrusions 737 formed at peripheral portions of the plate 738.

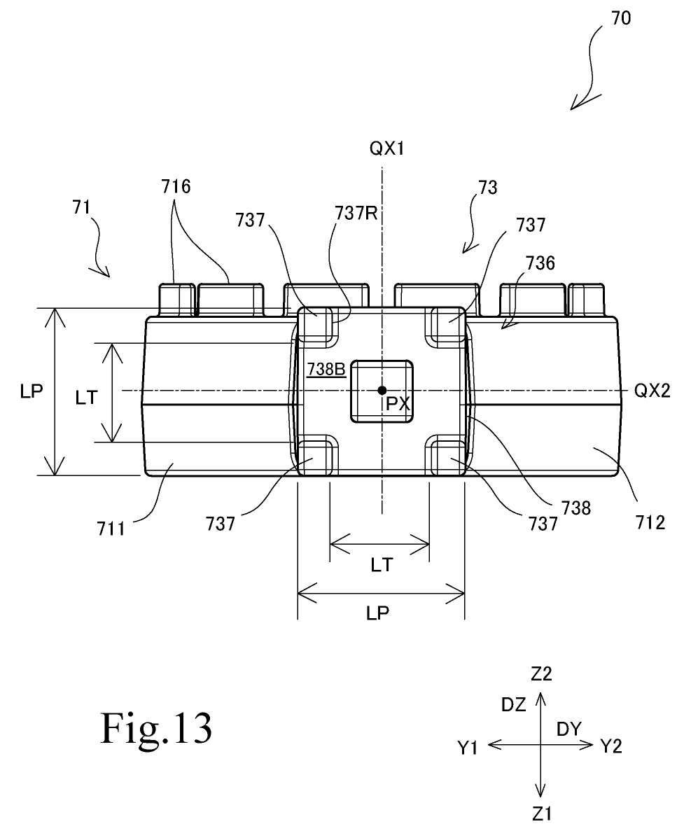

As shown in FIG. 6, the plate 738 is a plate-shaped member in which a surface 738B orthogonal to the long axis PX is formed at the second direction second side X2. As shown in FIG. 13, the surface 738B has a substantially square shape in which each of sides thereof has a length LP.

As shown in FIG. 6, the plurality of protrusions 737 protrude toward the second direction second side X2 from four corners of the surface 738B. Each of the plurality of protrusions 737 has a substantially square columnar shape. Recesses 737R are defined by facing surfaces of each of the adjacent protrusions 737 and the surface 738B of the plate 738.

As shown in FIG. 13, a distance between the adjacent protrusions 737, namely, a width of each of the recesses 737R is a distance LT, and is an equal interval. The distance LT is substantially the same as the width SW of the shaft portion 42 of the restricting member 40 shown in FIG. 5. In other words, the shaft portion 42 is configured to be able to be disposed in the recess 737R. In the present embodiment, the extending portion 73 includes the four protrusions 737. The four protrusions 737 restrict the shaft portion 42 disposed in the recess 737R from rotating around the long axis PX with respect to the extending portion 73.

Further, as schematically shown in FIG. 13, the shaft portion 42 is configured to be able to be disposed, with respect to the extending portion 73, in either of a first arrangement QX1 in which the long axis QX of the shaft portion 42 extends in the first direction DZ, or in a second arrangement QX2 in which the long axis QX of the shaft portion 42 extends in the third direction DY. By adopting this type of configuration, the orientation of the long axis QX of the shaft portion 42 with respect to the long axis PX of the extending portion 73 can be switched between two rotation angles orthogonal to each other.

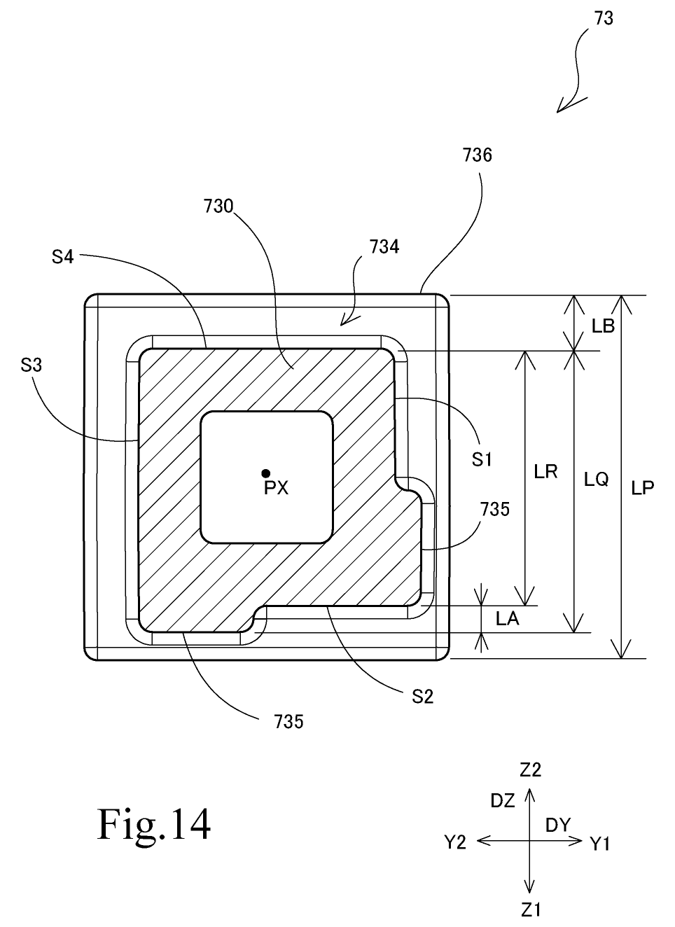

As shown in FIG. 14, at a position of the base portion 730 at which the recess 734 is formed, a cross-sectional orthogonal to the long axis PX has a substantially square shape in which the length of one side is a length LR. The base portion 730 at the position at which the recess 734 is formed has a side S1 disposed on the third direction first side Y1 with respect to the long axis PX, a side S2 disposed on the first direction first side Z1 with respect to the long axis PX, a side S3 disposed on the third direction second side Y2 with respect to the long axis PX, and a side S4 disposed on the first direction second side Z2 with respect to the long axis PX. The length from an outer edge of the angle determining portion 736 to of each of the sides S1 to S4, namely, a depth of the recess 734, is a length LB.

Of the four sides S1 to S4, protrusions 735 that protrude toward the outer side in the radial direction by a length LA are formed at the side S1 and the side S2. Note that a sum of the length LA and the length LR is a length LQ.

### Configuration of Coupling Member 80

As shown in FIG. 4, the coupling member 80 couples the attachment member 70 and the restricting member 40. In the present embodiment, the coupling member 80 can switch the orientation of the long axis QX of the shaft portion 42 with respect to the long axis PX of the extending portion 73 of the attachment member 70 between the two rotation angles orthogonal to each other. Further, the coupling member 80 can fix the orientation of the restricting member 40 at a plurality of rotation angles centering on the long axis QX.

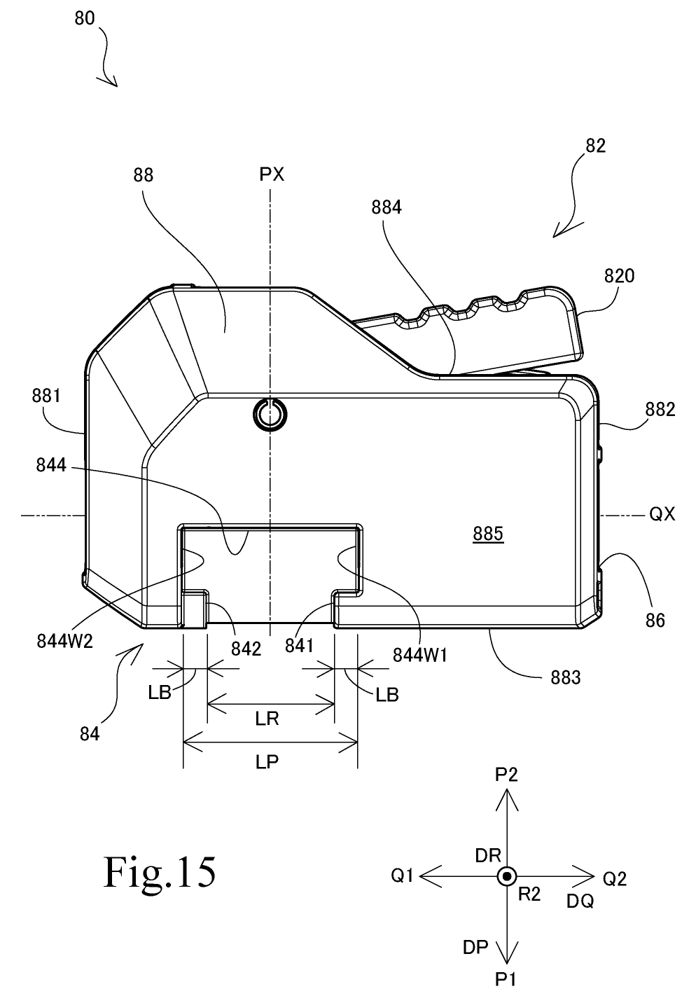

As shown in FIG. 15, the coupling member 80 includes a main body 88 having a substantially square shape. The main body 88 configures an outer contour of the coupling member 80. A shaft fixing portion 82, a band attachment portion 84, and an insertion portion 86 are provided in the main body 88. The shaft fixing portion 82 fixes the shaft portion 42 housed in the insertion portion 86.

The insertion portion 86 is a through hole penetrating the main body 88 in the first direction. As will be described below, the insertion portion 86 can house the shaft portion 42 such that the extending direction of the insertion portion 86 is parallel to the long axis QX of the shaft portion 42.

The band attachment portion 84 is a recess formed in the outer surface of the main body 88. As will be described below, the band attachment portion 84 can house the angle determining portion 736 of the extending portion 73 such that the long axis PX of the extending portion 73 of attachment member 70 and the long axis QX of the shaft portion 42 housed in the insertion portion 86 are orthogonal to each other.

In the following description, as necessary, in relation to directions of the coupling member 80, an extending direction of the insertion portion 86 is defined as a fourth direction DQ. In the present embodiment, as will be described below, a side at which the stopper portion 44 of the restricting member 40 is disposed with respect to the coupling member 80 is defined as a fourth direction first side Q1, and the opposite side is defined as a fourth direction second side Q2. Further a direction corresponding to the long axis PX of the extending portion 73 housed in the band attachment portion 84 is defined as a fifth direction DP. A side at which the attachment member 70 is disposed with respect to the coupling member 80 is defined as a fifth direction first side P1, and the opposite side is defined as a fifth direction second side P2. A direction orthogonal to the fourth direction DQ and the fifth direction DP is defined as a sixth direction DR. As shown in FIG. 4, when the attachment 200 attached to the oscillating tool 100 is in the first state, the side at which the grip portion 252 is disposed with respect to the coupling member 80 is defined as a sixth direction first side R1, and the side at which the tip tool 91 is disposed is defined as a sixth direction second side R2.

Further, as shown in FIG. 15, in relation to the outer surface of the main body 88, a surface disposed on the fourth direction first side Q1 with respect to a center point of the main body 88 is also referred to as a first surface 881, and an outer surface disposed on the fourth direction second side Q2 with respect to the center point is also referred to as a second surface 882. An outer surface disposed on the fifth direction first side P1 with respect to the center point is also referred to as a third surface 883, and an outer surface disposed on the fifth direction second side P2 is also referred to as a fourth surface 884. An outer surface disposed on the sixth direction second side R2 with respect to the center point is also referred to as a fifth surface 885, and an outer surface disposed on the sixth direction first side R1 is also referred to as a sixth surface 886.

### Configuration of Insertion Portion 86 and Shaft Fixing Portion

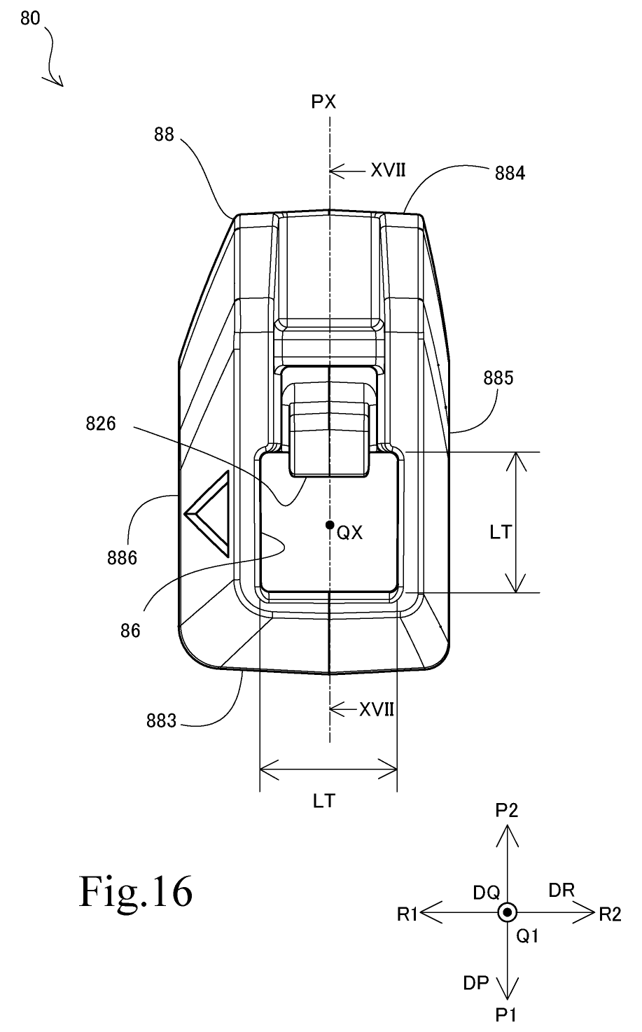

As shown in FIG. 15 and FIG. 16, the insertion portion 86 is the through hole joining the first surface 881 and the second surface 882 in the fourth direction DQ. The shaft portion 42 of the restricting member 40 is inserted into the insertion portion 86. The shaft portion 42 can be housed in the insertion portion 86 such that the fourth direction DQ and the long axis QX of the shaft portion 42 are parallel to each other.

As shown in FIG. 16, the insertion portion 86 has a substantially square shape corresponding to the cross-sectional shape of the shaft portion 42 orthogonal to the long axis QX. By adopting this type of configuration, the insertion portion 86 can cause the shaft portion 42 to be disposed in four directions while switching a rotation angle of the shaft portion 42 around the long axis QX at 90-degree intervals corresponding to the square shape. Thus, by rotating the shaft portion 42, the user can switch the extending direction of the stopper portion 44 coupled to the tip end of the shaft portion 42 to a desired direction from a direction D1 to a direction D4 shown in FIG. 4. Note that the direction D1 is a direction in which a position of a tip end 44E of the stopper portion 44 is disposed on the third direction first side Y1 with respect to the shaft portion 42. A direction D2 is a direction in which the position of the tip end 44E is disposed on the second direction first side X1 with respect to the shaft portion 42. A direction D3 is a direction in which the position of the tip end 44E is disposed on the third direction second side Y2 with respect to the shaft portion 42. The direction D4 is a direction in which the position of the tip end 44E is disposed on the second direction second side X2 with respect to the shaft portion 42.

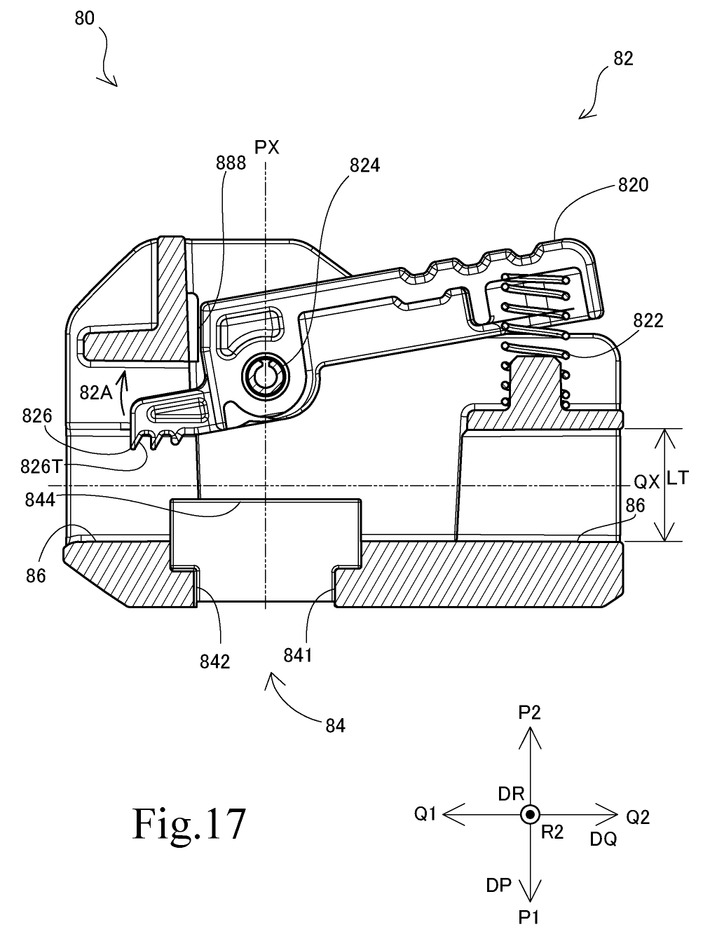

As shown in FIG. 17, the shaft fixing portion 82 includes a lever 820 a coil spring 822, a shaft 824, and a claw 826.

The claw 826 is formed at the end portion on the fourth direction first side Q1 of the lever 820. The claw 826 is configured to be able to engage with the plurality of teeth 421 formed on the shaft portion 42 of the restricting member 40 shown in FIG. 5.

The lever 820 is held at the main body 88 so as to be able to rotate around the shaft 824. The end portion on the fourth direction second side Q2 of the lever 820 is urged in a direction separating from the insertion portion 86 by the coil spring 822. Thus, the lever 820 is normally held at a position (hereinafter also referred to as a “meshing position”) in contact with a restricting portion 888 formed in the main body 88.

As shown in FIG. 17, when the lever 820 is disposed at the meshing position, the claw 826 is inserted into the insertion portion 86. As a result of the user pushing the lever 820 toward the insertion portion 86 in resistance to the urging force of the coil spring 822, the user can cause the claw 826 to move in the direction of an arrow 82A shown in FIG. 17, and can withdraw the claw 826 from the insertion portion 86. The position at which the claw 826 is withdrawn from the insertion portion 86 is also referred to as a “non-meshing position”.

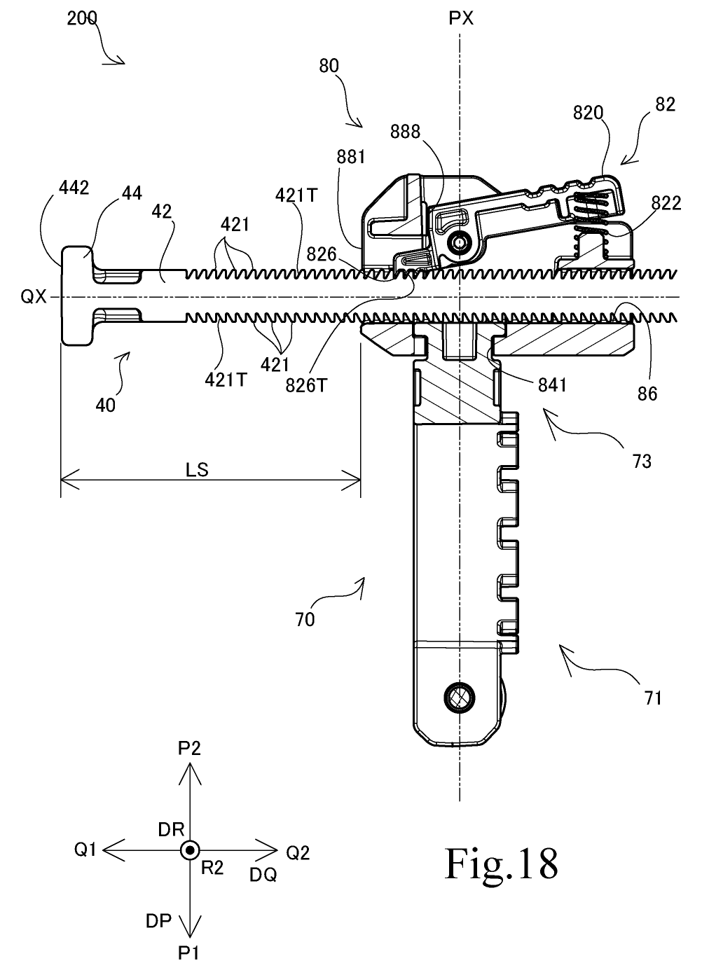

As shown in FIG. 18, by being meshed with one of the plurality of teeth 421 of the shaft portion 42 inserted into the insertion portion 86, the claw 826 disposed at the meshing position can engage the shaft portion 42 at a desired position in the fourth direction DQ. For example, by pressing the lever 820 and disposing the claw 826 at the non-meshing position, the user can slide the shaft portion 42 inside the insertion portion 86 in the fourth direction DQ, and by releasing the lever 820, can engage the shaft portion 42 at the desired position in the fourth direction DQ. By being configured in this way, the user can adjust a distance LS from the coupling member 80 to the stopper portion 44 (more specifically, the distance LS from the first surface 881 of the main body 88 to the restricting surface 442 of the stopper portion 44) in the extending direction of the shaft portion 42. Note that, in the present embodiment, in the shaft portion 42, the distance between the adjacent teeth 421 is configured to be 1.5mm (millimeters) or less. Thus, the distance LS can be adjusted at intervals of 1.5mm or less. Note that the distance between the adjacent teeth 421 is not limited to being 1.5mm only, and can be set as a desired distance, such as 2.0mm, 1.0mm, 0.5mm, or the like.

In the present embodiment, the ratchet mechanism is employed for the shaft portion 42 and the shaft fixing portion 82 that restricts the movement direction of the shaft portion 42 with respect to the shaft fixing portion 82 to the fourth direction first side Q1. Specifically, as shown in FIG. 17, the claw 826 of the lever 820 includes an inclined portion 826T whose surface on the fourth direction second side Q2 is inclined. Further, as shown in FIG. 18, each of the teeth 421 of the shaft portion 42 has a triangular shape having an inclined portion 421T whose surface on the fourth direction first side Q1 is inclined. By being configured in this way, the user can slide the shaft portion 42 toward the fourth direction first side Q1 without pressing the lever 820. Further, as long as the lever 820 is not pressed, the shaft portion 42 does not slide toward the fourth direction second side Q2. Thus, the user can adjust the distance LS using a simple method.

### Configuration of Band Attachment Portion 84

As shown in FIG. 15 and FIG. 19, the band attachment portion 84 houses the angle determining portion 736 of the extending portion 73. By engaging the angle determining portion 736 in the band attachment portion 84, the attachment member 70 is fixed to the coupling member 80. The band attachment portion 84 includes the first restricting portion 841, the second restricting portion 842, and the housing portion 844.

The housing portion 844 is a recess formed in the main body 88. The housing portion 844 has a shape corresponding to the angle determining portion 736 of the extending portion 73. As shown in FIG. 15, a maximum length in the fourth direction DQ of the housing portion 844 is the length LP, and is substantially the same as the length LP of each of the sides of the plate 738 of the angle determining portion 736 shown in FIG. 13.

The first restricting portion 841 and the second restricting portion 842 are protruding portions protruding from wall surfaces defining the housing portion 844. The shape of the first restricting portion 841 and the second restricting portion 842 corresponds to the shape of the recess 734 of the extending portion 73. The first restricting portion 841 protrudes by the length LB toward the fourth direction first side Q1 from a wall surface 844W1 on the fourth direction second side Q2, of the side surfaces defining the housing portion 844. The length LB is substantially the same as the length LB from the outer edge of the angle determining portion 736 to each of the sides S1 to S4 of the recess 734 as shown in FIG. 14. In a similar manner to the first restricting portion 841, the second restricting portion 842 protrudes by the length LB toward the fourth direction second side Q2 from a wall surface 844W2 on the fourth direction first side Q1, of the wall surfaces defining the housing portion 844.

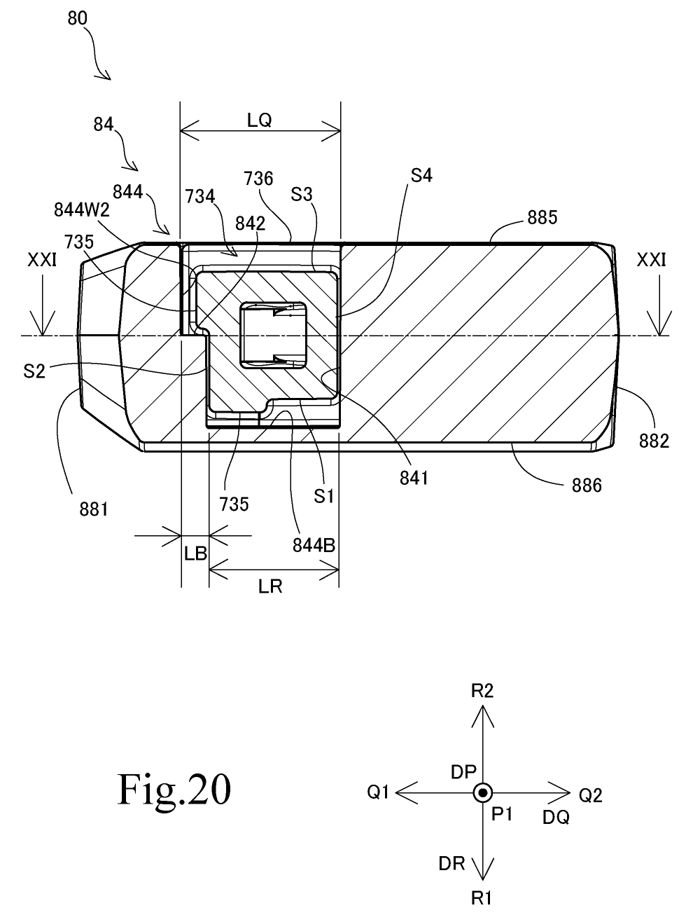

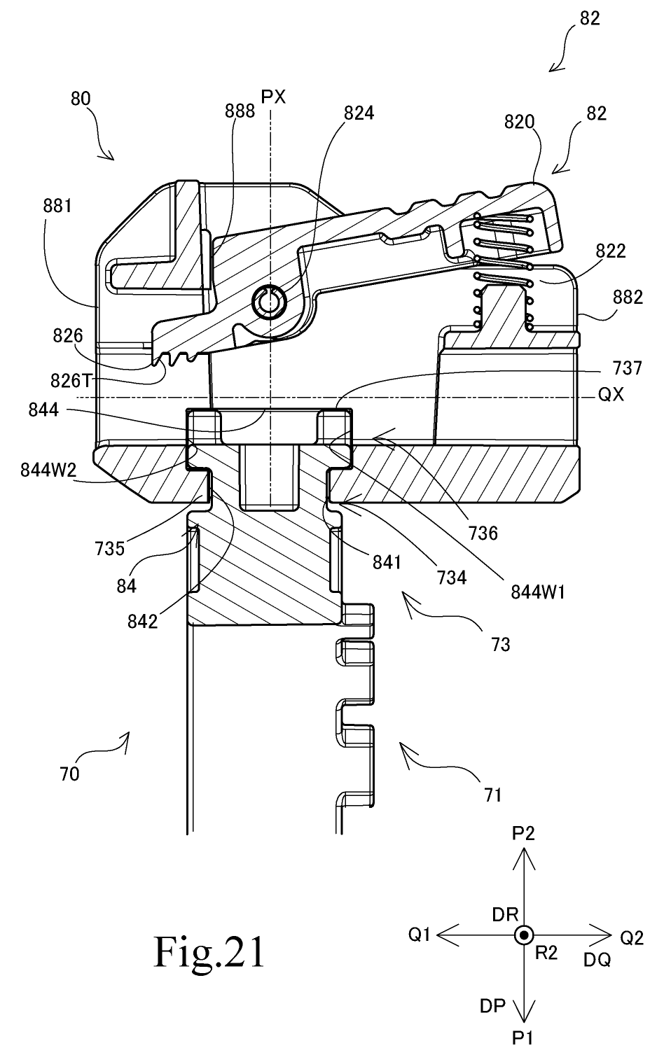

As shown in FIG. 19 and FIG. 20, when the angle determining portion 736 is housed in the housing portion 844, the first restricting portion 841 and the second restricting portion 842 are engaged with the recess 734. Note that, as shown in FIG. 21, when the angle determining portion 736 is housed in the housing portion 844, the protrusions 737 of the extending portion 73 are disposed, in the housing portion 844, at positions that do not interfere with the shaft portion 42.

In the present embodiment, the first restricting portion 841 and the second restricting portion 842 further function as direction restricting portions that restrict the direction in which the angle determining portion 736 is inserted into the housing portion 844 to a predetermined direction only. As shown in FIG. 20, the first restricting portion 841 and the second restricting portion 842 are configured to be asymmetrical with each other. More specifically, when the wall surface 844W1 on the sixth direction second side R2 of the housing portion 844 is a bottom portion 844B, while the first restricting portion 841 is formed from the bottom portion 844B as far as the fifth surface 885, the second restricting portion 842 is formed to a position in the vicinity of a midpoint of the wall surface 844W2 from the bottom surface 844B. In other words, a height of the second restricting portion 842 in the sixth direction DR is lower than a height of the first restricting portion 841 in the sixth direction DR. A space on the sixth direction first side R1 of the second restricting portion 842 can receive the protrusions 735 that protrude from the recess 734.

By being configured in this way, in a state in which the side S3 or the side S4 of the recess 734 of the extending portion 73 is oriented toward the sixth direction second side R2 (in a state in which the recess 734 and the bottom portion 844B face each other), the protrusions 735 are in contact with the second restricting portion 842. Since movement to the sixth direction second side R2 of the recess 734 is obstructed by the second restricting portion 842, the angle determining portion 736 can only enter partway into the housing portion 844. Thus, as shown in FIG. 20, the recess 734 is only housed in the housing portion 844 in a state in which the side S1 faces the bottom portion 844B oriented toward the sixth direction second side R2, or in a state in which the side S2 faces the bottom portion 844B oriented toward the sixth direction second side R2.

As shown in FIG. 20, in the state in which the side S1 of the recess 734 faces the bottom portion 844B, the long axis QX and the long axis OX (the drive axis TX) are parallel to each other. In other words, the attachment 200 is in the first state shown in FIG. 1 and FIG. 4. In the attachment 200 in the first state, the restricting surface 442 of the stopper portion 44 is disposed on the first direction first side Z1 of the attachment member 70.

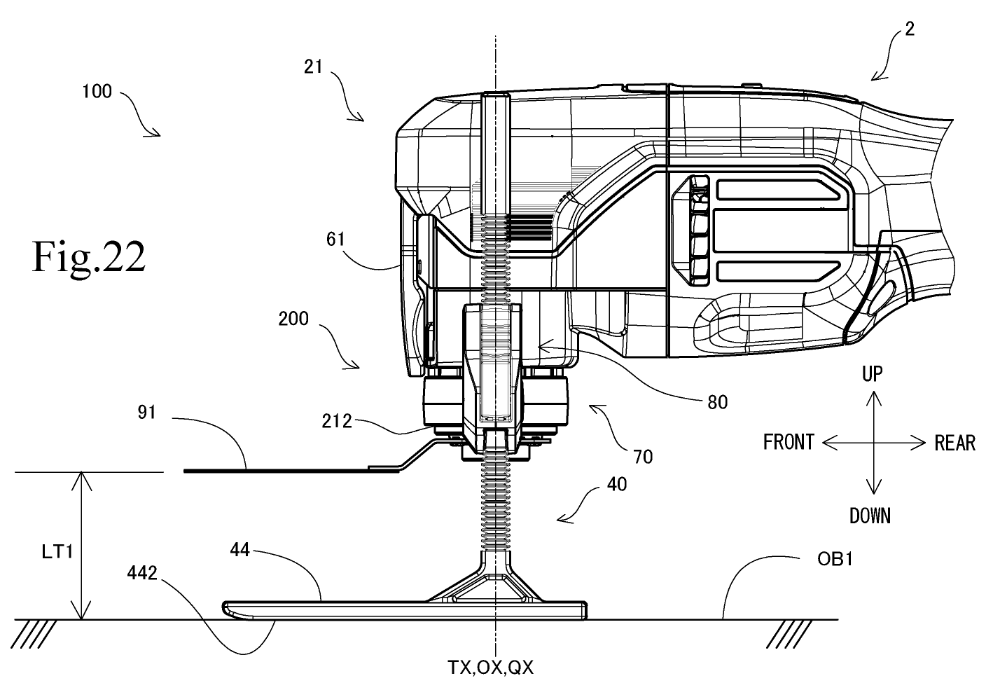

As shown in FIG. 22, the attachment 200 in the first state can dispose the restricting surface 442 of the stopper portion 44 at a position lower than the tip tool 91, for example. Thus, the user can perform the machining operation using the oscillating tool 100 while maintaining a distance LT1 between an object OB1 disposed below the oscillating tool 100 and the tip tool 91 to be constant.

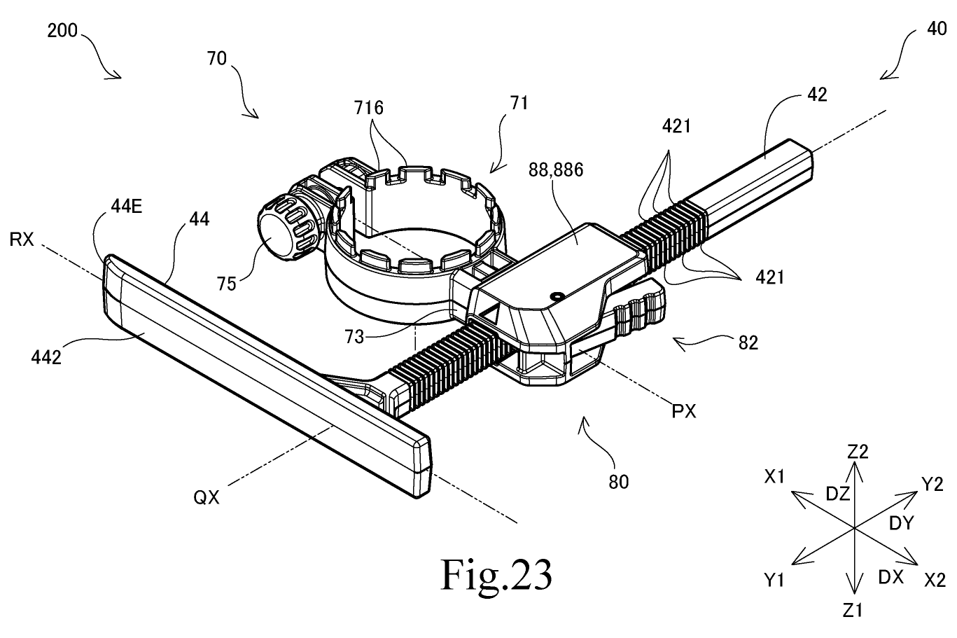

On the other hand, in the state in which the side S2 of the recess 734 faces the bottom portion 844B, the long axis QX and the long axis OX (the drive axis TX) are orthogonal to each other. The attachment 200 in this state is also referred to as being in a “second state”. As shown in FIG. 23, in the attachment 200 in the second state, the restricting surface 442 of the stopper portion 44 is disposed on the third direction first side Y1 of the attachment member 70. Note that, with the attachment 200 in the second state also, in a similar manner to the first state, by rotating the shaft portion 42 around the long axis QX, the extending direction of the stopper portion 44 coupled to the tip end of the shaft portion 42 can be switched to the desired direction from the direction D1 to the direction D4 (refer to FIG. 4).

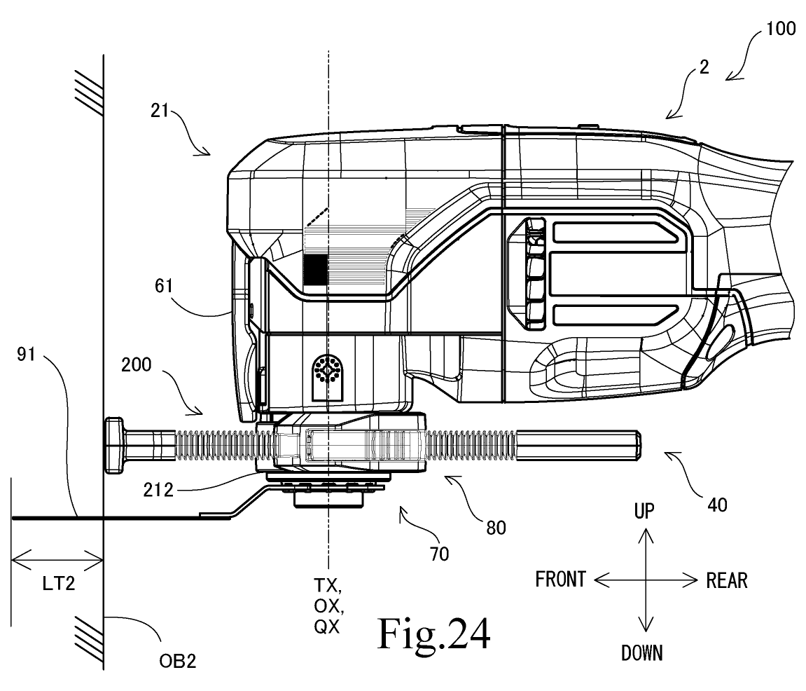

As shown in FIG. 24, in the attachment 200 in the second state, the restricting surface 442 of the stopper portion 44 can be disposed at a position further to the front than the drive axis TX, for example. Thus, the attachment 200 in the second state can limit the tip tool 91 from entering into a distance LT2 or more with respect to an object OB2 disposed in front of the oscillating tool 100.

### Effects

As described above, according to the attachment 200 according to the present embodiment, the restricting member 40 includes the shaft portion 42, and the stopper portion 44 coupled to the tip end of the shaft portion 42. The restricting surface 442 that is orthogonal to the long axis QX of the shaft portion 42 is formed on the stopper portion 44. Since the restricting surface 442 can be caused to be in surface contact with the object, the user can operate the oscillating tool 100 in a stable manner while restricting the relative position of the oscillating tool 100 with respect to the object to be no closer than the restricting surface 442.

In the attachment 200, the distance LS from the coupling member 80 to the stopper portion 44 is configured to be adjustable by the coupling member 80 switching the position at which the claw 826 of the shaft fixing portion 82 comes into contact with the teeth 421 of the shaft portion 42. Thus, the user can switch the position of the restricting surface 442 with respect to the coupling member 80 to a desired position along the long axis QX of the shaft portion 42. Further, by using the ratchet mechanism that utilizes the meshing between the claw 826 and the teeth 421, the position of the stopper portion 44 with respect to the coupling member 80 can be fixed using the simple configuration.

In the attachment 200, the insertion portion 86 of coupling member 80 has the substantially square shape corresponding to the cross-sectional shape of the shaft portion 42. Thus, the shaft portion 42 can be inserted in the state of being rotated to the four rotation angles at the 90-degree intervals centering on the long axis QX. As a result, the user can switch the orientation of the stopper portion 44 coupled to the shaft portion 42 to the four rotation angles with respect to the coupling member 80.

As a result of the engagement of the extending portion 73 of the attachment member 70 and the band attachment portion 84, the coupling member 80 is configured to be able to be coupled to the attachment member 70 in states in which the restricting member 40 has been rotated to the plurality of rotation angles centering on the long axis PX of the extending portion 73. Thus, the user can adjust the extending direction of the shaft portion 42 with respect to the drive axis TX of the oscillating tool 100 (the orientation of the long axis QX) to the plurality of rotation angles around the long axis PX of the extending portion 73.

When the attachment member 70 is attached to the oscillating tool 100, the coupling member 80 is configured to be able to switch the state of the attachment 200 between the first state in which the long axis QX of the shaft portion 42 and the drive axis TX of the tip tool 91 are parallel to each other, and the second state in which the long axis QX of the shaft portion 42 is parallel to the front-rear direction. Thus, the user can switch the arrangement of the restricting surface 442 of the stopper portion 44 to be at a position lower than the tip tool 91 or to be at a position further to the front than the drive axis TX, as desired, in accordance with content of the machining operation by the oscillating tool 100, a type of the workpiece, an operation environment at the time of the machining operation, and the like.

The clamp portion 71 is configured to be able to attach, to the oscillating tool 100, the attachment member 70 rotated to the plurality of rotation angles centering on the drive axis TX. Thus, the user can adjust the arrangement of the coupling member 80 with respect to the drive axis TX to the plurality of rotation angles centering on the drive axis TX.

In the present embodiment, in the clamp portion 71 of the attachment member 70, the recesses 717 are disposed at the equal intervals at the twelve locations in the peripheral direction centering on the long axis OX. Thus, the user can adjust the rotational angle of the attachment member 70 with respect to the circular cylindrical portion 212 at 3- degree intervals around the drive axis TX.

The attachment member 70 includes the distance adjustment portion 75 that can adjust the separation distance L2 between the first main body 711 and the second main body 712. Thus, the user can attach and remove the attachment member 70 to and from the circular cylindrical portion 212 or rotate the attachment member 70 with respect to the circular cylindrical portion 212 without using a dedicated tool.

The attachment member 70 is configured to be able to adjust the separation distance L2 by an amount corresponding to the thickness TH or more by which the engagement protrusion 215 protrude from the outer surface of the circular cylindrical portion 212 of the oscillating tool 100. Thus, the user can rotate the attachment member 70 with respect to the circular cylindrical portion 212 using the simple method of adjusting the separation distance L2 by the amount corresponding to the thickness TH or more, using the distance adjustment portion 75. Further, by adjusting the separation distance L2 by the amount roughly corresponding to the thickness TH, the user can rotate the clamp portion 71 around the drive axis TX while suppressing or preventing the attachment member 70 from falling off from the circular cylindrical portion 212.

### Second Embodiment

### Configuration of Oscillating Tool 100b

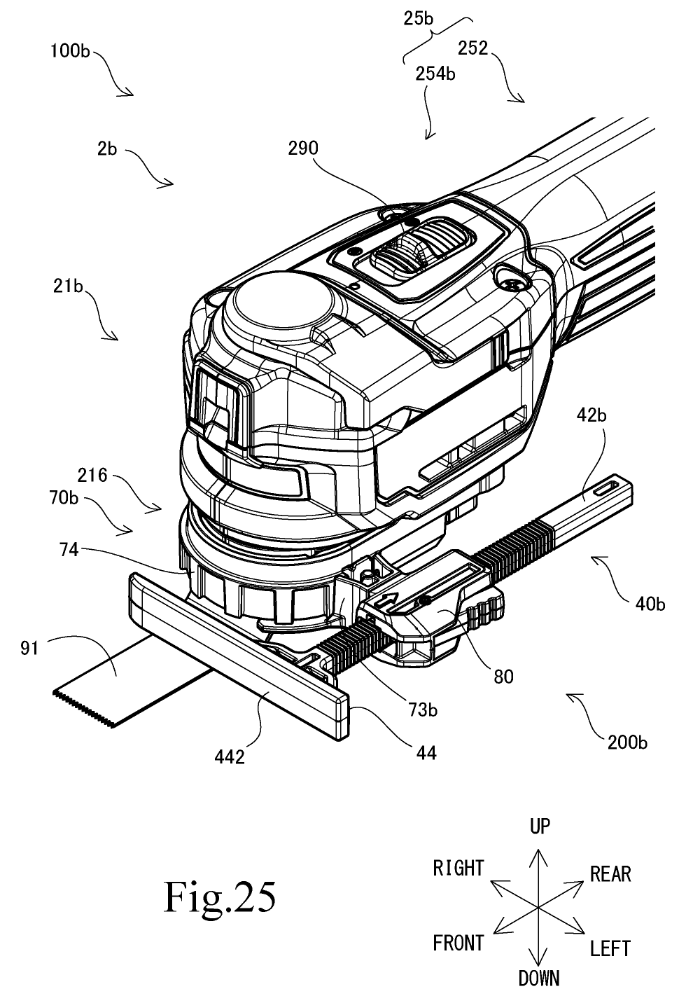

As shown in FIG. 25, an oscillating tool 100b according to a second embodiment differs from the oscillating tool 100 according to the first embodiment in that the oscillating tool 100b includes a housing 2b instead of the housing 2. Other configurations are the same. An attachment 200b is detachably attached to the oscillating tool 100b instead of the attachment 200.

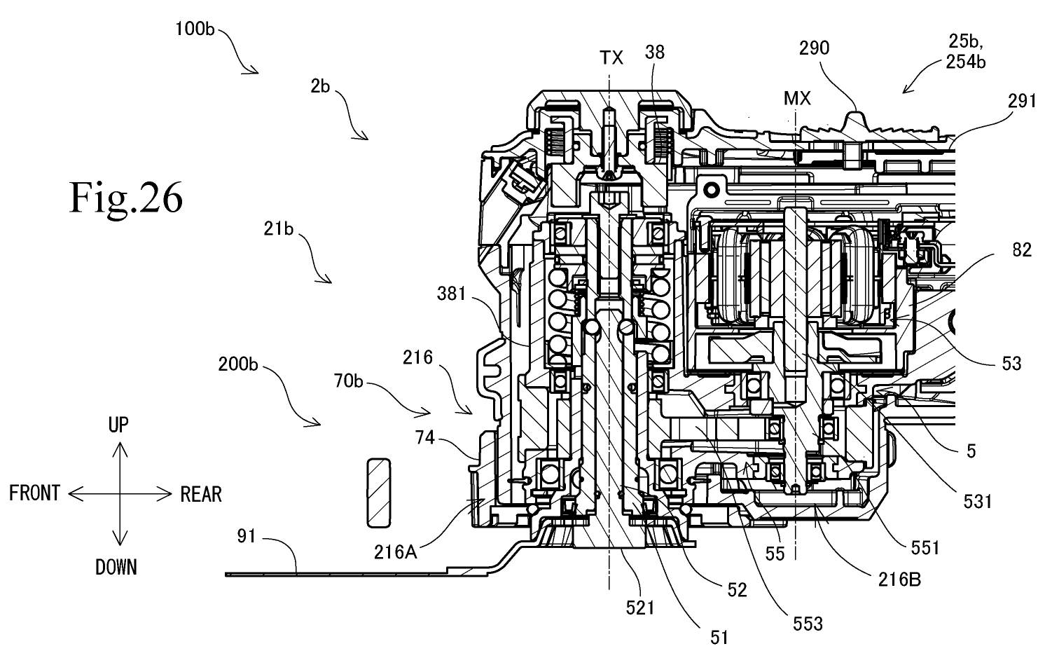

As shown in FIG. 26, the housing 2b differs from the housing 2 in that the housing 2b includes a central portion 25b instead of the central portion 25 and includes a front-end portion 21b instead of the front-end portion 21. The central portion 25b includes a motor housing 254b in which a configuration of the drive mechanism 5, such as the arrangement of the motor 53 and the like differs from that of the motor housing 254 shown in the first embodiment. The motor housing 254b houses the motor 53 such that the rotation axis MX of the output shaft 531 of the motor 53 and the drive axis TX of the spindle 51 are parallel to each other. The front-end portion 21b differs from the configuration of the front-end portion 21 in that a rectangular portion 216 is formed instead of the circular cylindrical portion 212. The rectangular portion 216 houses the motor 53 having the different arrangement to that of the circular cylindrical portion 212, and the transmission mechanism 55 disposed at a position corresponding to the arrangement of the motor 53. In other words, in the housing 2b, instead of the circular cylindrical portion 212, the rectangular portion 216 is formed that has the shape corresponding to the difference in the configuration of the drive mechanism 5.

### Configuration of Attachment 200b

### Configuration of Attachment Member 70B

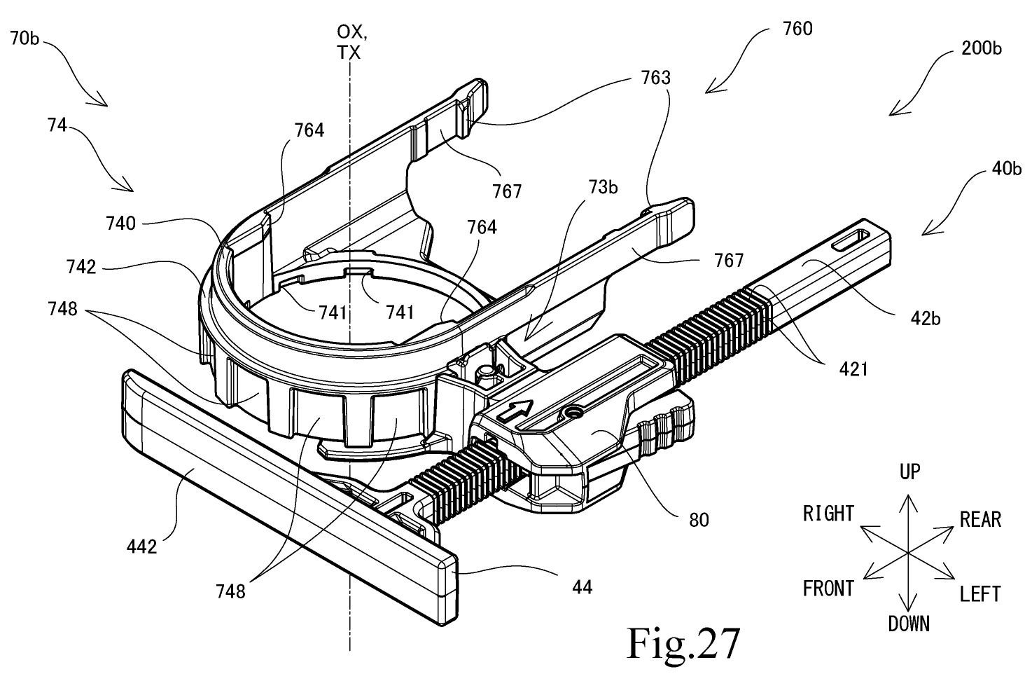

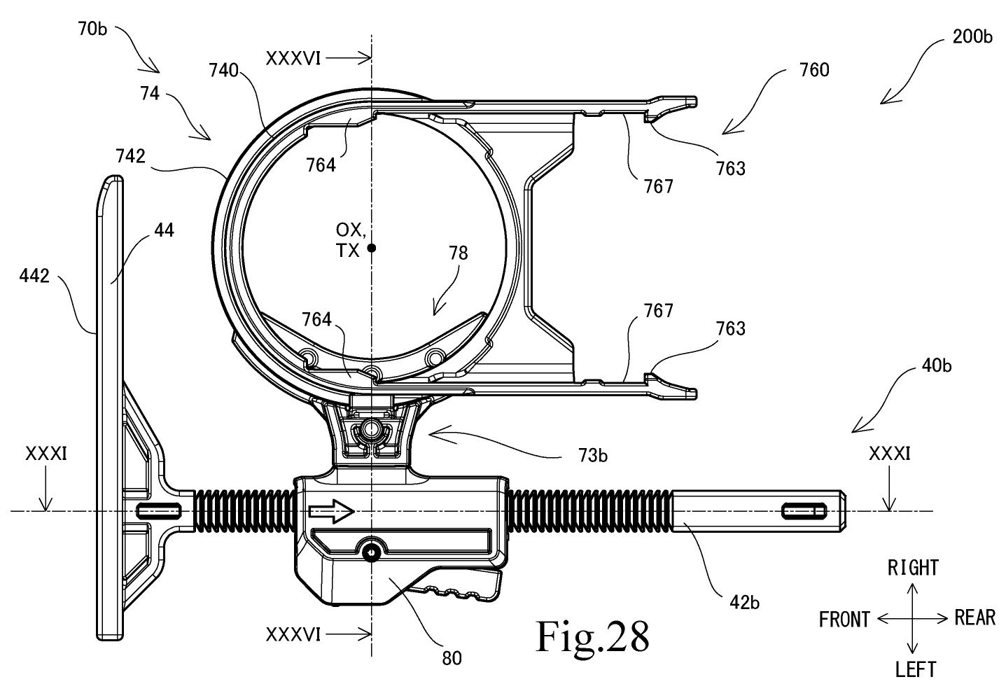

As shown in FIG. 27 and FIG. 28, the configuration of the attachment 200b according to the second embodiment differs from the configuration of the attachment 200 according to the first embodiment in that the attachment 200b includes an attachment member 70b instead of the attachment member 70 and includes a restricting member 40b instead of the restricting member 40. Other configurations are the same. The attachment member 70b includes an attachment portion 74 and an extending portion 73b.

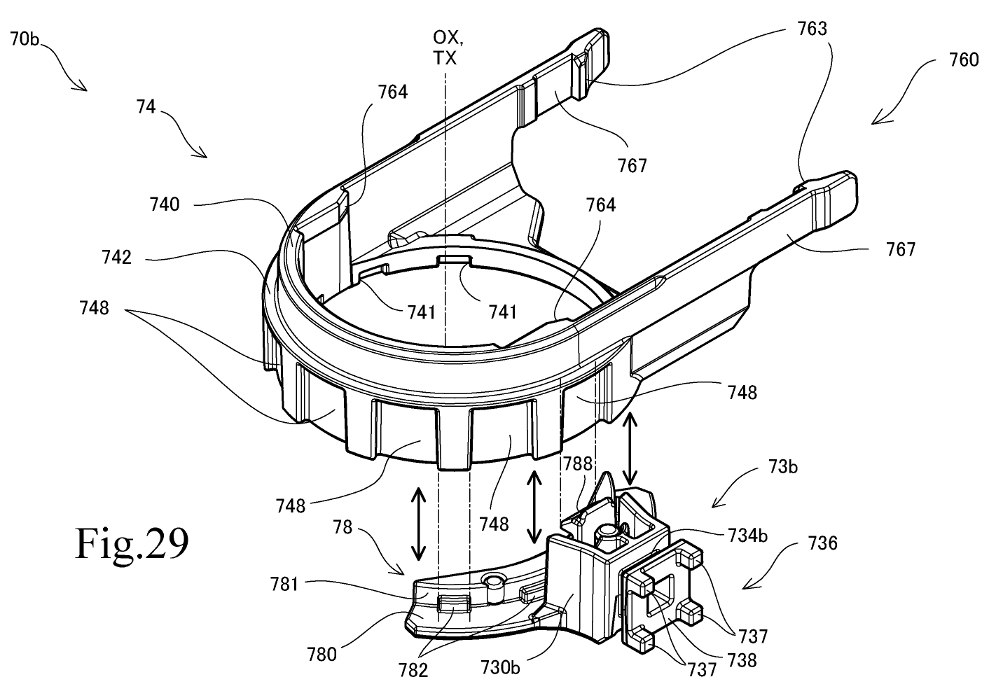

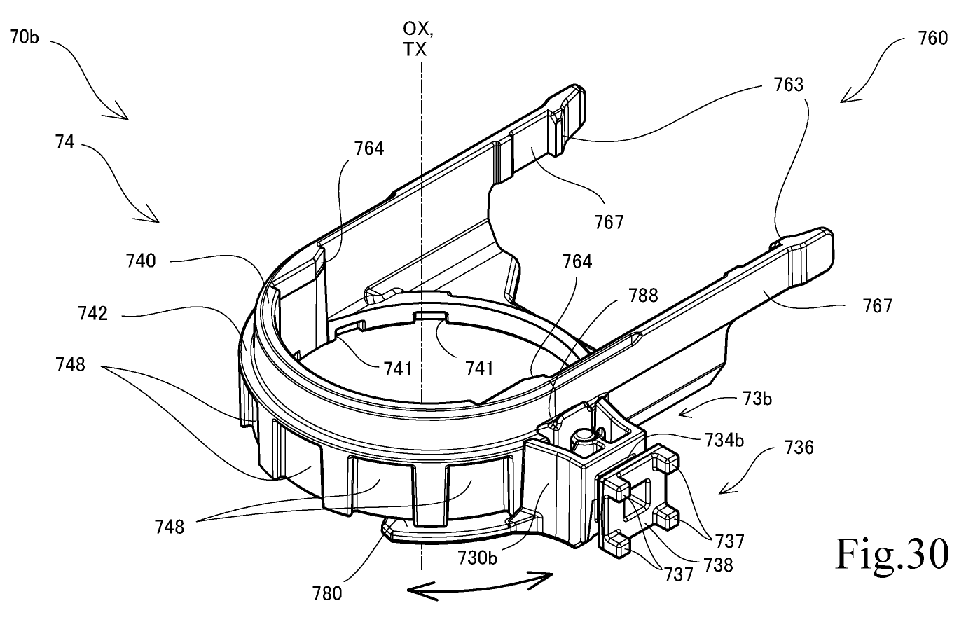

In the attachment 200 according to the above-described first embodiment, the example is described in which the arrangement of the coupling member 80 with respect to the drive axis TX is adjusted to the plurality of rotation angles centering on the drive axis TX, by rotating the entire attachment member 70 around the circular cylindrical portion 212 of the oscillating tool 100. In contrast, in the present embodiment, as shown in FIG. 29 and FIG. 30, in the attachment 200b according to the present embodiment, the arrangement of the coupling member 80 with respect to the drive axis TX is adjusted to the plurality of rotation angles centering on the drive axis TX by attaching and detaching the extending portion 73b from the attachment portion 74 and switching the attachment position of the extending portion 73b around the drive axis TX with respect to the attachment portion 74.

### Configuration of Restricting Member 40b

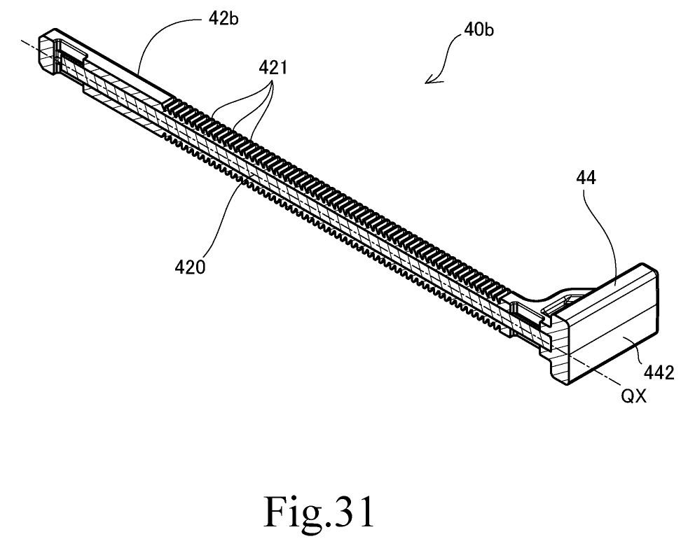

As shown in FIG. 31, the configuration of the restricting member 40b differs from the configuration of the restricting member 40 described in the first embodiment in that the restricting member 40b includes a shaft portion 42b instead of the shaft portion 42. Other configurations are the same as those of the restricting member 40. As shown in FIG. 31, the shaft portion 42b has the same configuration as the shaft portion 42 described in the first embodiment in that the shaft portion 42b is a long member extending in a straight line, and differs from the shaft portion 42 in including a metal shaft 420 inside the shaft portion 42b.

The metal shaft 420 is a metal rod-shaped member extending along the long axis QX of the shaft portion 42b. By arranging the metal shaft 420 inside the shaft portion 42b, the strength of the shaft portion 42b can be improved. It is thus possible to suppress or prevent the shaft portion 42b from bending, while forming the shaft portion 42b using a high polymer material, such as a resin material, an elastomer, and the like. Further, compared to a case in which the shaft portion 42 as a whole is formed from a metal material, it is possible to make the shaft portion 42b lighter. Note that the attachment 200b may include the restricting member 40 described in the first embodiment instead of the restricting member 40band may include the shaft portion 42 instead of the shaft portion 42b. In this case, the shaft portion 42b as a whole may be formed from a high polymer material, such as a resin material, an elastomer, and the like, or may be formed from a metal material.

### Configuration of Attachment Portion 74

As shown in FIG. 25, the attachment portion 74 is non-rotatably fixed to the rectangular portion 216 of the oscillating tool 100b. As shown in FIG. 27, the attachment portion 74 includes a main body 740 and a restricting portion 760 coupled to the main body 740. The main body 740 and the restricting portion 760 have a shape corresponding to the shape of the rectangular portion 216 of the oscillating tool 100b.

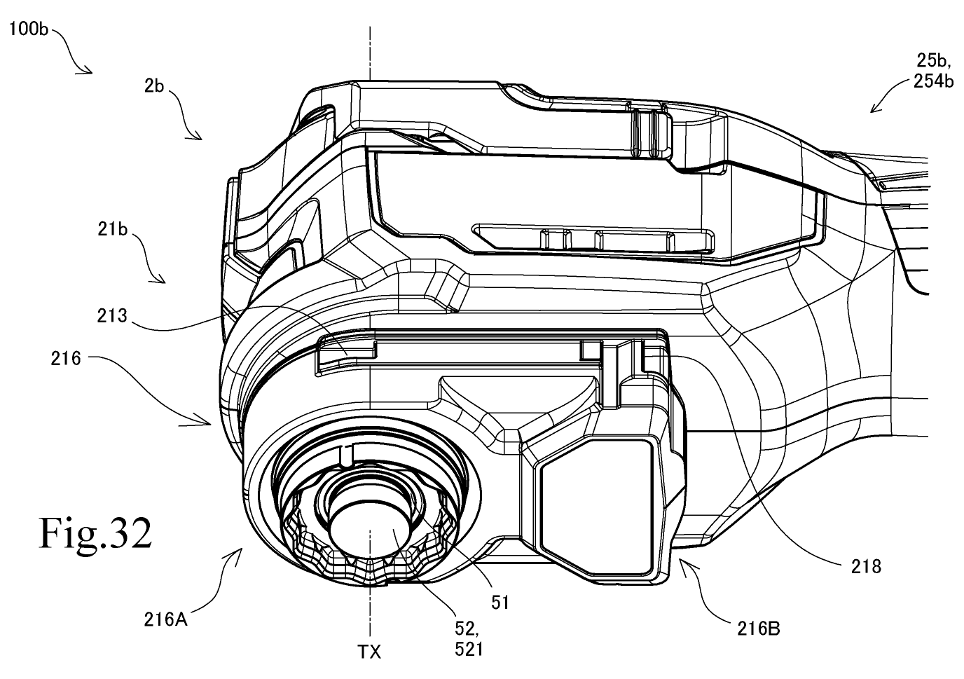

In FIG. 32, the oscillating tool 100b is shown from which the tip tool 91 and the attachment 200b have been removed. As shown in FIG. 32, the rectangular portion 216 includes a first housing portion 216A surrounding the spindle 51, and a second housing portion 216B disposed further to the rear than the first housing portion 216A and housing the transmission mechanism 55.

A pair of third engagement portions 213 that have a recessed shape are formed in the left and right-side surfaces of the first housing portion 216A. A pair of engagement recesses 218 are formed in the left and right-side surfaces of the second housing portion 216B. The pair of third engagement portions 213 and the pair of engagement recesses 218 are arrayed on a straight line in the front-rear direction.

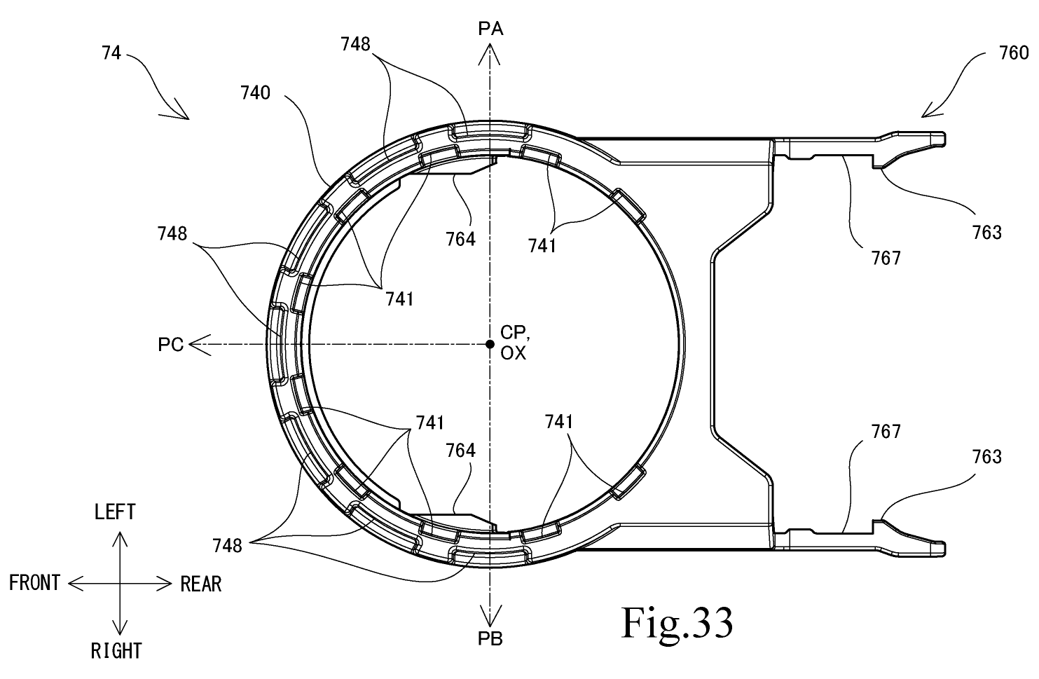

As shown in FIG. 33, the main body 740 has a substantially circular annular shape in a plan view. The main body 740 is attached to the first housing portion 216A of the rectangular portion 216. Specifically, the main body 740 is fixed to the first housing portion 216A such that a center point CP of an opening having a circular annular shape in the main body 740 is disposed on the drive axis TX. In the present embodiment, the center point CP of the opening of the main body 740 is aligned with the long axis OX of the attachment portion 74. In other words, when the attachment portion 74 is attached to the rectangular portion 216 of the front-end portion 21b, the drive axis TX is aligned with the long axis OX, and passes through the center point CP. As will be described later, a plurality of first engagement portions 741 and a plurality of guide portions 748 are formed in the main body 740.

As shown in FIG. 27, the restricting portion 760 fixes the main body 740 to the second housing portion 216B of the rectangular portion 216 so as not to be able to move. As shown in FIG. 33, the restricting portion 760 includes a pair of fourth engagement portions 764, and a pair of engagement claws 763.

The pair of fourth engagement portions 764 have a substantially rectangular shape and protrude toward the center point CP of the main body 740. The pair of fourth engagement portions 764 are configured to engage with the pair of third engagement portions 213 formed in the first housing portion 216A of the rectangular portion 216 shown in FIG. 32. By the engagement between the pair of fourth engagement portions 764 and the pair of third engagement portions 213, the movement of the main body 740 to the rear, the movement of the main body 740 in a direction corresponding to the drive axis TX (the up-down direction), and the rotation of the main body 740 around the drive axis TX are restricted. Note that a configuration may be adopted in which the engagement between the pair of third engagement portions 213 and the pair of fourth engagement portions 764 is obtained by the pair of fourth engagement portions 764 having a recessed shape and the pair of third engagement portions 213 having a protruding shape.

As shown in FIG. 27, the pair of engagement claws 763 are formed at tip ends of a pair of base portions 767 extending in a straight line to the rear from the main body 740. The pair of engagement claws 763 have a snap fit structure that utilizes elasticity of the pair of base portions 767, and are configured to engage with the pair of engagement recesses 218 formed in the second housing portion 216B of the rectangular portion 216 shown in FIG. 32. As a result of the engagement between the pair of engagement claws 763 and the pair of engagement recesses 218, the movement of the main body 740 to the rear, the movement of the main body 740 in the direction corresponding to the drive axis TX (the up-down direction), and the rotation of the main body 740 around the drive axis TX are restricted. Note that the second housing portion 216B may include a pair of engagement protrusions instead of the pair of engagement recesses 218. In this case, by forming engagement recesses at the tip ends of the pair of base portions 767 instead of the pair of engagement claws 763, the pair of engagement recesses may be configured to engage with the pair of engagement protrusions.

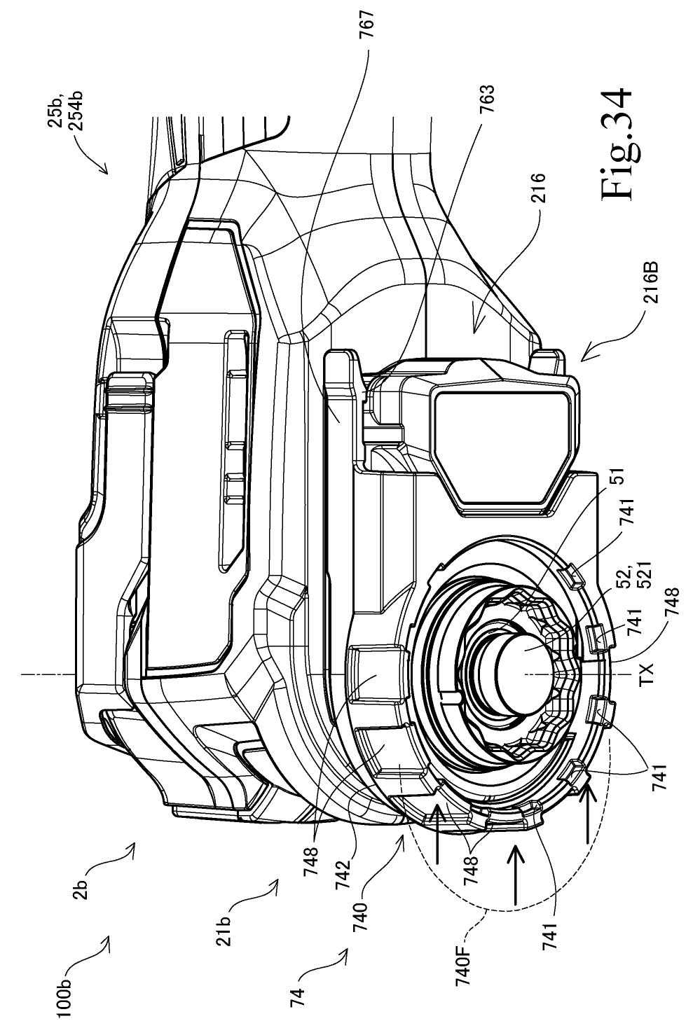

As shown by a broken line in FIG. 34, when attaching the attachment portion 74 to the rectangular portion 216, the main body 740 is provisionally disposed such that the front end of the main body 740 is at a position 740F in front of the rectangular portion 216. As shown in FIG. 34, by moving the main body 740 in the rearward direction, the pair of fourth engagement portions 764 engage with the pair of third engagement portions 213, and the pair of engagement claws 763 engage with the pair of engagement recesses 218. As a result, the attachment portion 74 is fixed to the rectangular portion 216.

Note that the restricting portion 760 is not limited to the shape having the snap fit structure shown in the present embodiment, and may have a desired shape, as long as the main body 740 can be fixed to the front-end portion 21b of the housing 2b. For example, the restricting portion 760 may include fitting portions that fit with part of the front-end portion 21b, instead of the engagement claws 763. Further, when the main body 740 includes a configuration that can be fixed to the front-end portion 21b, the restricting portion 760 may be omitted. The attachment portion 74 may be configured to attach to the circular cylindrical portion 212 shown in the first embodiment, instead of the rectangular portion 216.

### Configuration of Extending Portion 73b

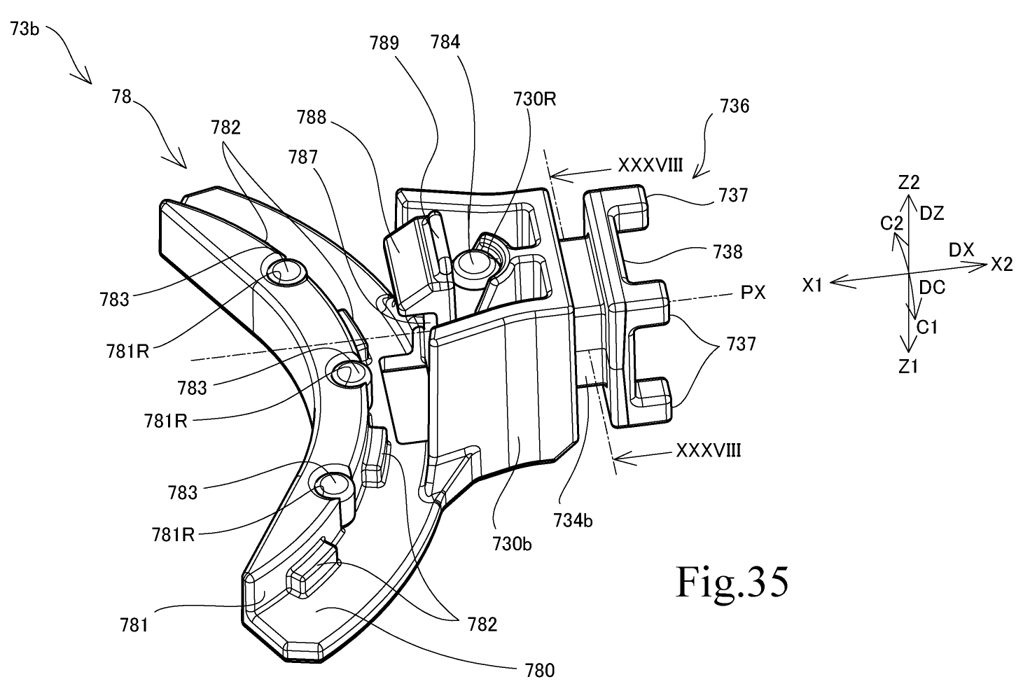

As shown in FIG. 27, the extending portion 73b couples the attachment member 70b and the coupling member 80 to each other. As shown in FIG. 29, the extending portion 73b is detachably attached to the attachment portion 74. As shown in FIG. 35, the extending portion 73b differs from the extending portion 73 shown in the first embodiment in that the extending portion 73b includes a base portion 730b instead of the base portion 730, includes a recess 734b instead of the recess 734, and further includes a rotational coupling portion 78. Other configurations are the same.

As shown in FIG. 35, the rotational coupling portion 78 fixes the base portion 730b to the attachment portion 74. Specifically, the rotational coupling portion 78 is configured to fix the base portion 730b such that the long axis PX is oriented to a desired rotation angle around the drive axis TX. The rotational coupling portion 78 includes a blate 780, a wall portion 781, second engagement portions 782, and an engagement claw 788.

As shown in FIG. 29, the plate 780 comes into contact with the lower end of the main body 740. As shown in FIG. 35, the plate 780 has a substantially circular arc shape having a radius of curvature corresponding to the circular annular shape of the main body 740 in a plan view.

In the following description, as necessary, in relation to directions of the attachment 200b, the direction corresponding to the long axis OX of the attachment portion 74 is defined as the first direction DZ. When the attachment member 70b is attached to the oscillating tool 100b, the side at which the tip tool 91 is disposed with respect to the attachment member 70b is defined as the first direction first side Z1, and the opposite side is defined as the first direction second side Z2. Further, the extending direction of the extending portion 73b (the direction corresponding to the long axis PX) is defined as the second direction DX. The second direction DX can also be referred to as the radial direction centering on the drive axis TX, the long axis OX, or the center point CP. The side at which the attachment portion 74 is disposed with respect to the extending portion 73b is defined as the second direction first side X1, and the opposite side (the side on which the coupling member 80 is disposed) is defined as the second direction second side X2. The second direction first side X1 can also be referred to as the inner side in the radial direction, and the second direction second side X2 can also be referred to as the outer side in the radial direction. A direction orthogonal to the first direction DZ and to the second direction DX, and in which the plate 780 extends is defined as a radial direction DC. When the oscillating tool 100b to which the attachment 200b is attached is viewed from above, as shown in FIG. 25, the clockwise direction with respect to the drive axis TX is defined as a peripheral direction first side C1, and the counterclockwise direction is defined as a peripheral direction second side C2.

The wall portion 781 is coupled to the second direction first side X1 of the plate 780 and extends toward the first direction second side Z2 from the plate 780. When the extending portion 73b is attached to the attachment portion 74, the surface on the second direction second side X2 of the wall portion 781 faces the inner peripheral surface of the main body 740, and the surface on the second direction first side X1 of the wall portion 781 faces the long axis OX.

A distance from the wall portion 781 to the base portion 730b, in other words, the width of the plate 780 in the second direction DX, is configured to be slightly wider than the thickness of the main body 740 of the attachment portion 74 in the second direction DX. By being configured in this way, the main body 740 can easily be caused to fit between the wall portion 781 and the base portion 730b, and the attachment and detachment of the extending portion 73b and the attachment portion 74 can be easily performed. Thus, the direction of the restricting member 40 can be easily switched.

Recesses 781R are formed in the wall portion 781. First elastic bodies 783 each having a substantially circular columnar shape are disposed in the recesses 781R. The first elastic body 783 is a desired elastic body made of silicon rubber, for example. The first elastic body 783 is housed in the recess 781R such that a part of the first elastic body 783 protrudes toward the second direction second side X2 from a wall surface of the wall portion 781.

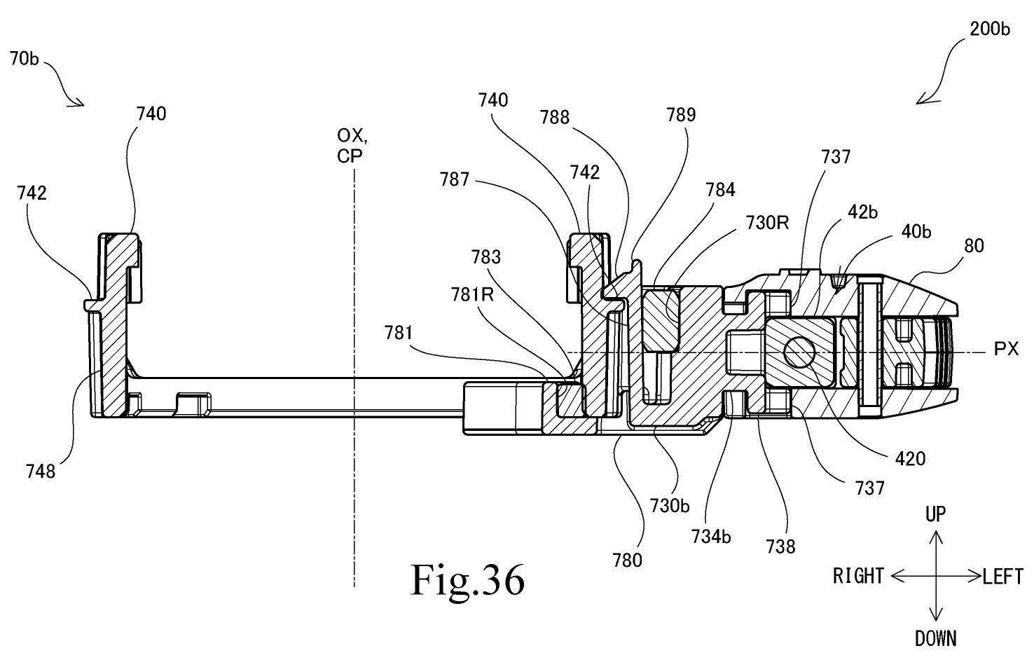

As shown in FIG. 36, when the attachment portion 74 is coupled to the extending portion 73b, the first elastic bodies 783 apply pressure to the main body 740 disposed on the plate 780. By being configured in this way, even when the width of the plate 780 in the second direction DX is configured to be slightly wider than the thickness of the main body 740 of the attachment portion 74 in the second direction DX, it is possible to suppress or prevent the main body 740 from rattling between the base portion 730b and the wall portion 781. Note that, in the present embodiment, the example is shown in which the number of the recesses 781R and the first elastic bodies 783 is three, but the number of the recesses 781R and the first elastic bodies 783 may be singular or may be any desired number of two or more. Further, when the extending portion 73b is fixed to the attachment portion 74 in a stable manner, the recesses 781R and the first elastic bodies 783 may be omitted.

The engagement claw 788 is a part of the base portion 730b, and is coupled to the second direction second side X2 of the plate 780 via a base portion 787 extending in the first direction DZ. The base portion 787 faces the wall portion 781 of the plate 780.

The engagement claw 788 is formed at the tip end on the first direction second side Z2 of the base portion 787, and protrudes toward the second direction first side X1. As shown in FIG. 36, the engagement claw 788 has a snap fit structure that utilizes elasticity of the base portion 787. When the extending portion 73b is attached to the attachment portion 74, the engagement claw 788 is engaged with a shoulder portion 742 of the main body 740. As a result, the main body 740 of the attachment portion 74 is clamped on the plate 780 by the wall portion 781 (more specifically, the first elastic bodies 783) and the engagement claw 788, and the attachment portion 74 and the extending portion 73b are coupled to each other. By displacing the engagement claw 788 engaged with the shoulder portion 742 toward the second direction second side X2 in resistance to the elastic force of the base portion 787, the engagement of the engagement claw 788 with the shoulder portion 742 can be released.

As shown in FIG. 35, an operation portion 789 is formed on the engagement claw 788. The operation portion 789 protrudes toward the first direction second side Z2 from the tip end of the engagement claw 788 and is configured to be easily hooked by a finger of the user. Thus, by manually operating the operation portion 789, the user can easily release the engagement between the engagement claw 788 and the shoulder portion 742.

The base portion 730b couples the rotational coupling portion 78 and the angle determining portion 736. Of the base portion 730b, a recess 730R for disposing a second elastic body 784 is formed in the second direction second side X2 of the engagement claw 788. The second elastic body 784 is a desired elastic body made of silicon rubber, for example, and has a substantially circular columnar shape. By disposing the second elastic body 784 to the rear of the engagement claw 788, a load and a concentration of stress on the base portion 787 caused by elastic deformation of the engagement claw 788 can be suppressed, and it is possible to suppress or prevent damage or wear of the engagement claw 788. Note that the recess 730R and the second elastic body 784 may be omitted.

As shown in FIG. 35, the second engagement portions 782 are formed on the surface on the first direction second side Z2 of the plate 780. The second engagement portions 782 have a substantially cuboid shape, and are configured to be engaged with the plurality of first engagement portions 741 formed in a recess shape in the main body 740 shown in FIG. 33. By the engagement between the first engagement portions 741 and the second engagement portions 782, movement of the rotational coupling portion 78 with respect to the main body 740 in the peripheral direction DC is suppressed. In other words, the rotation of the extending portion 73b around the long axis OX with respect to the attachment portion 74 is suppressed. Note that, in the example shown in FIG. 35, the four second engagement portions 782 are disposed at equal intervals in the peripheral direction DC on the plate 780, but the number of the second engagement portions 782 is not limited to being four, and may be singular, or may be a desired number of two or more.

Note that, instead of on the plate 780, the second engagement portions 782 may be formed on the second direction second side X2 of the wall portion 781, on the second direction first side X1 of the base portion 787, or on the second direction first side X1 of the base portion 730b. In other words, the second engagement portions 782 may be disposed at desired positions on the rotational coupling portion 78, based on the premise that the second engagement portions 782 engage with the first engagement portions 741 formed at desired positions in the main body 740.

As shown in FIG. 33, the main body 740 includes the plurality of first engagement portions 741. In the present embodiment, the number of the first engagement portions 741 is ten. Note that the number of the first engagement portions 741 used for coupling the main body 740 and the extending portion 73b corresponds to the number of the second engagement portions 782 formed on the plate 780 (four in the present embodiment).

The arrangement of the first engagement portions 741 around the center point CP of the main body 740 corresponds to rotational angles around the drive axis TX. The interval between the plurality of first engagement portions 741 is the rotational angle of 30 degrees around the center point CP. In the present embodiment, engagement positions of the second engagement portions 782 and the plurality of first engagement portions 741 are configured to be changeable at seven locations at the 30-degree intervals, in a range of 180 degrees around the center point CP and to the front of the center point CP.

More specifically, as shown in FIG. 33, the position of the extending portion 73b with respect to the center point CP of the attachment portion 74 is configured to be switchable at the 30-degree intervals in a range from a first position PA to a second position PB. At the first position PA, the extending direction of the extending portion 73b (the direction corresponding to the long axis PX) is substantially parallel to the left-right direction, and the extending portion 73b is disposed to the right of the center point CP. At the second position PB, the long axis PX is substantially parallel to the left-right direction, and the extending portion 73b is disposed to the left of the center point CP. By disposing the extending portion 73b at a position PC directly to the front of the center point CP, for example, it is possible to dispose the restricting member 40b such that the long axis QZ of the shaft portion 42b extends in the left-right direction.

As shown in FIG. 29, the plurality of guide portions 748 are formed in the main body 740. The plurality of guide portions 748 are recesses formed in the outer surface of the main body 740. The shape of the guide portion 748 corresponds to the shape of the engagement claw 788 of the extending portion 73b. Specifically, a width of each of the guide portions 748 in the peripheral direction DC is substantially the same as the width of the engagement claw 788 of the extending portion 73b in the peripheral direction DC. As shown in FIG. 33, the arrangement and the number of the plurality of guide portions 748 around the long axis OX of the attachment portion 74 correspond to the rotation angles around the long axis OX at which the extending portion 73b can be disposed. In the present embodiment, the guide portions 748 are formed at seven locations at 30-degree intervals around the long axis OX in the range from the first position PA to the second position PB.

### Method of Changing Arrangement of Restricting Member 40b Around Drive Axis TX

When changing the arrangement of the restricting member 40b around the drive axis TX, the user of the attachment 200b first removes the extending portion 73b from the attachment portion 74. By manually operating the operation portion 789 coupled to the engagement claw 788, the user displaces the engagement claw 788 to the second direction second side X2. As a result of this, the engagement between the engagement claw 788 of the extending portion 73b and the shoulder portion 742 of the main body 740 is released. As shown in FIG. 29, the user can remove the extending portion 73b from the attachment portion 74 by moving the extending portion 73b downward with respect to the attachment portion 74.

The user disposes the extending portion 73b at the desired rotation angle with respect to the main body 740. At the same time as causing the end portion on the first direction first side Z1 of the main body 740 to come into contact with the surface on the first direction second side Z2 of the plate 780, the user causes the four second engagement portions 782 to engage with the four first engagement portions 741 corresponding to the desired rotation angle. At this time, by aligning the position of the engagement claw 788 with the position of the guide portion 748 corresponding to the desired angle, of the seven guide portions 748, the user can appropriately determine the position of the extending portion 73b with respect to the attachment portion 74. Further, an operator can determine the position of the main body 740 and the extending portion 73b at the desired rotation angle without visually verifying the positions of the first engagement portions 741 and the positions of the second engagement portions 782.

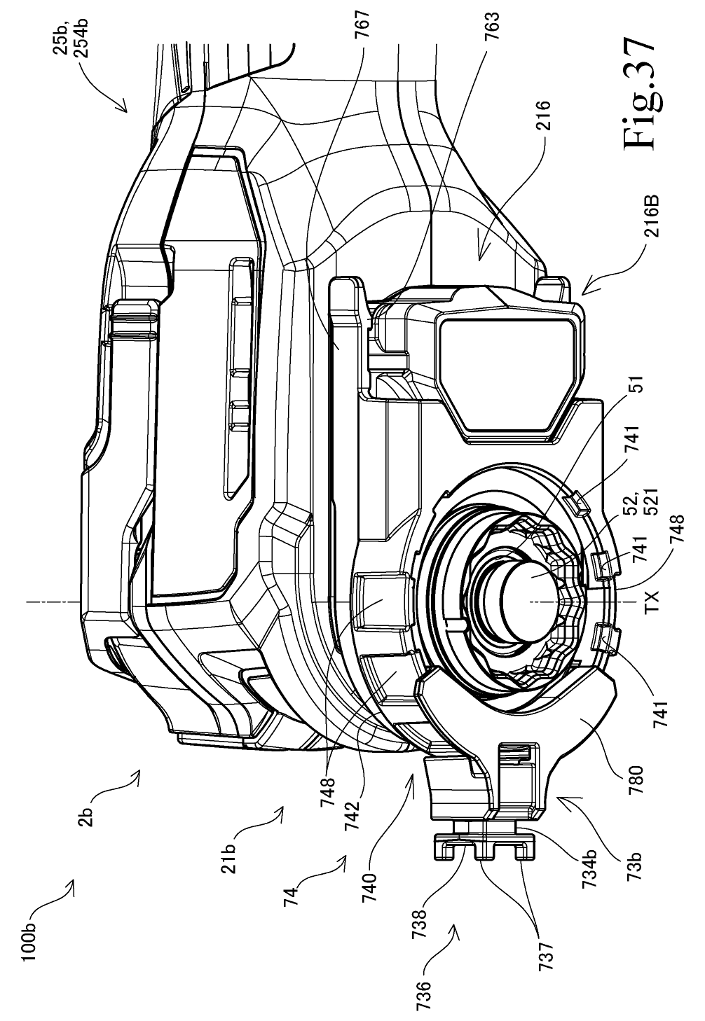

When the operator fits the engagement claw 788 into the guide portion 748 and moves the extending portion 73b to the first direction second side Z2, an inclined surface on the first direction second side Z2 of the engagement claw 788 comes into contact with the lower end of the shoulder portion 742. When the operator moves the extending portion 73b further toward the first direction second side Z2, the engagement claw 788 is displaced further to the outer side by the contact between the inclined surface of the engagement claw 788 and the shoulder portion 742 and passes over the shoulder portion 742. The engagement claw 788 that has passed over the shoulder portion 742 is restored from the displacement to the outer side and engages with the shoulder portion 742. As a result, as shown in FIG. 37, the extending portion 73b is fixed so as not to be rotatable with respect to the main body 740 of the attachment portion 74.

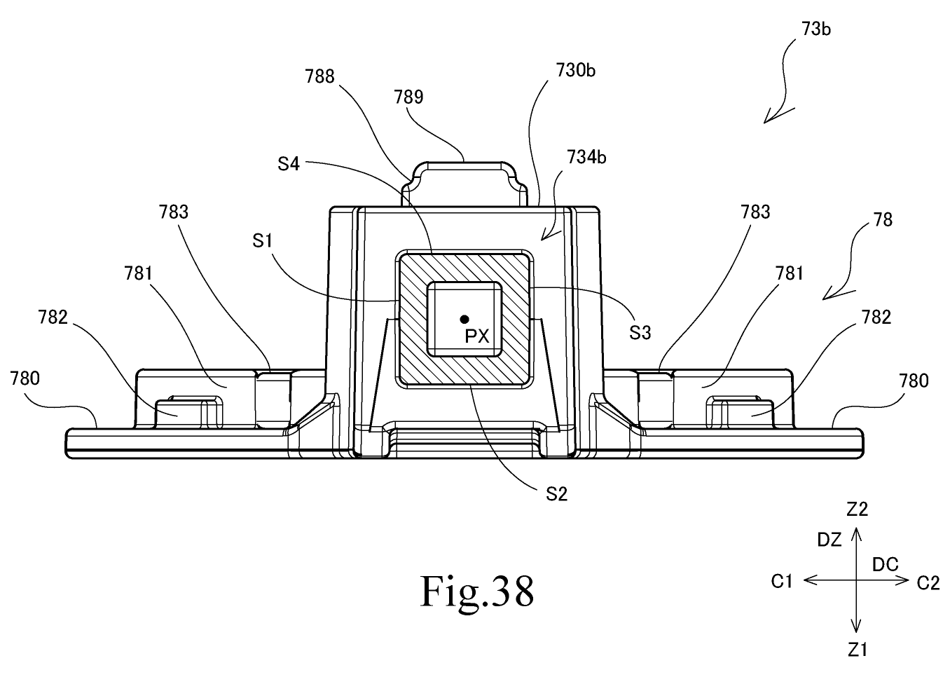

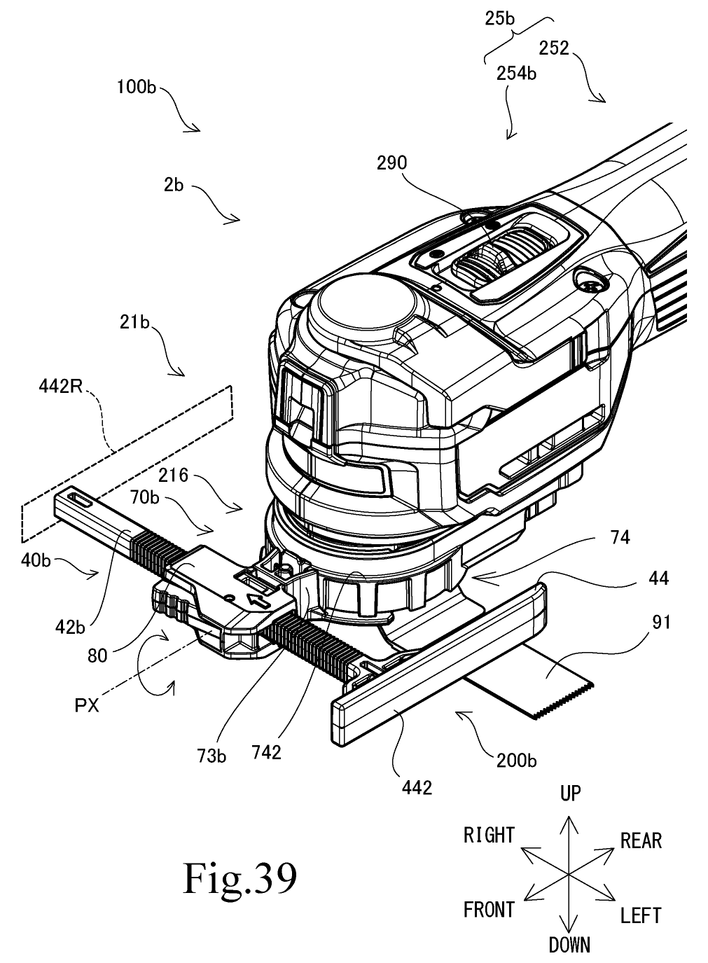

As shown in FIG. 38, a cross-sectional shape of a section of the base portion 730b in which the recess 734b is formed differs from the cross-sectional shape of the recess 734 shown in the above-described first embodiment in that the recess 743b does not include the protrusions 735. By being configured in this way, in the present embodiment, the band attachment portion 84 of the coupling member 80 can house the angle determining portion 736 of the extending portion 73b without any difference in function at the different directions at the 90-degree intervals. In other words, the orientation of the shaft portion 42b can be switched in the four directions around the long axis PX of the extending portion 73b. Thus, even when the range of the rotation angles at which the extending portion 73b can be disposed around the drive axis TX is at the front of the drive axis TX and is smaller than the range of the first embodiment, as shown in FIG. 39, for example, it is possible to dispose the restricting surface 442 of the stopper portion 44 of the shaft portion 42b at a position further to the left side than the drive axis TX in a similar manner to the first embodiment, while disposing the extending portion 73b directly in front of the drive axis TX. Further, as shown by a broken line 442R in FIG. 39, the restricting surface 442 of the stopper portion 44 can be disposed further to the right side than the extending portion 73b without switching the position of the extending portion 73b disposed directly in front of the drive axis TX.

### Effects

As described above, the attachment 200b according to the present embodiment includes the attachment member 70b, the restricting member 40b, and the coupling member 80. The attachment member 70b is detachably attached to the oscillating tool 100b. The restricting member 40b comes into contact with the object and restricts the relative movement of the oscillating tool 100b with respect to the object. When the attachment member 70b is attached to the oscillating tool 100b, the coupling member 80 couples the restricting member 40b and the attachment member 70b such that the long axis QX of the shaft portion 42b and the drive axis TX are parallel to each other. Thus, in a similar manner to the attachment 200 according to the first embodiment, with the attachment 200b according to the second embodiment also, the user can operate the oscillating tool 100b in the stable manner while restricting the relative position of the oscillating tool 100b with respect to the object up to the restricting surface 442.

According to the present embodiment, the attachment member 70b includes the attachment portion 74 and the extending portion 73b. The attachment portion 74 is configured to attach the extending portion 73b at the plurality of rotation angles about the drive axis TX. Thus, instead of attaching and detaching the attachment portion 74 to and from the oscillating tool 100b, the arrangement of the restricting member 40b around the drive axis 40b can be switched using the simple method of attaching and detaching the extending portion 73b to and from the attachment portion 74 that is fixed to the oscillating tool 100b.

According to the present embodiment, the attachment portion 74 includes the main body 740 having the cylindrical shape surrounding the drive axis TX. The extending portion 73b is configured to be attached at positions of the main body 740 at the plurality of rotation angles around the drive axis TX. Thus, using the simple method of attaching and detaching the extending portion 73b to and from the attachment portion 74 that is fixed to the oscillating tool 100b, it is possible to switch the arrangement of the restricting member 40b to the desired rotation angle around the drive axis TX.

According to the present embodiment, the attachment portion 74 includes the main body 740 having the cylindrical shape surrounding the drive axis TX. The extending portion 73b is configured to be attached at positions of the main body 740 at the plurality of rotation angles. Thus, using the simple method of attaching and detaching the extending portion 73b to and from the attachment portion 74 that is fixed to the oscillating tool 100b, it is possible to switch the arrangement of the restricting member 40b to the desired rotation angle.

According to the present embodiment, the extending portion 73b includes the plate 780, the wall portion 781, and the engagement claw 788. The plate 780 extends in the second direction DX that is orthogonal to the drive axis TX when the attachment portion 74 is attached to the oscillating tool 100b, and in the third direction DY (the peripheral direction DC). The wall portion 781 extends from the plate 780 in the first direction DZ that is parallel to the drive axis TX. The engagement claw 788 extends from the plate 780 in the first direction DZ that is parallel to the drive axis TX and is disposed facing the wall portion 781. The main body 740 of the attachment portion 74 is disposed on the plate 780 between the wall portion 781 and the engagement claw 788. The engagement claw 788 is configured to engage with the shoulder portion 742 of the attachment portion 74 when the main body 740 is disposed between the wall portion 781 and the engagement claw 788. As a result of clamping the attachment portion 74 on the plate 780 between the wall portion 781 and the engagement claw 788, it is possible to strongly couple the attachment portion 74 and the extending portion 73b. Thus, it is possible to suppress or prevent the extending portion 73b from falling off from the attachment portion 74.

According to the present embodiment, when engaging the engagement claw 7688 with a part of the attachment portion 74, the attachment portion 74 includes the plurality of guide portions 748 that guide the engagement claw 788 to the part of the attachment portion 74. The user can appropriately determine the position of the extending portion 73b with respect to the main body 740 using the simple method of aligning the position of the engagement claw 788 with the position of the guide portion 748 corresponding to the desired rotation angle. Further, the operator can determine the position of the main body 740 and the extending portion 73b at the desired rotation angle without visually verifying the first engagement portions 741 and the second engagement portions 782.

According to the present embodiment, the attachment portion 74 includes the first engagement portions 741 each having the recess shape. The extending portion 73b includes the second engagement portions 782 each having the protruding shape that engages with the first engagement portion 741. By the simple method of engaging the first engagement portions 741 with the second engagement portions 782, the movement of the extending portion 73b with respect to the attachment portion 74 can be restricted, and the restricting member 40b can be strongly fixed to the attachment portion 74.

According to the present embodiment, the attachment portion 74 includes the restricting portion 760 that engages the attachment portion 74 with the rectangular portion 216 of the housing 2b. The restricting portion 760 restricts the main body 740 from moving with respect to the drive axis TX. Thus, it is possible to strongly fix the attachment 200b to the oscillating tool 100b.

According to the present embodiment, inside the shaft portion 42b of the restricting member 40b, the metal shaft 420 is provided that extends in the extending direction of the shaft portion 42b. It is thus possible to suppress or prevent the shaft portion 42b from bending, while forming the shaft portion 42b using a high polymer material, such as a resin material, an elastomer, and the like. Further, compared to the case in which the shaft portion 42b as a whole is formed from a metal material, it is possible to make the shaft portion 42b lighter.

The oscillating tools 100 and 100b are an example of a “power tool”. The attachments 200 and 200b are an example of a “power tool attachment”. The tip tool 91 and the drive axis TX are an example of a “tip tool” and a “drive axis”. The attachment members 70 and 70b, the restricting members 40 and 40b, and the coupling member 80 are an example of an “attachment member”, a “restricting member”, and a “coupling member”. The shaft portions 42 and 42b, the restricting surface 442, and the stopper portion 44 are an example of a “shaft portion”, a “restricting surface” and a “stopper portion”. The insertion portion 86 is an example of an “insertion portion”. The lever 820 and the claw 826 are an example of a “fixing portion”. The teeth 421 of the shaft portion 42 are an example of a “first engagement portion”, and the claw 826 is an example of a “second engagement portion”. The clamp portion 71 is an example of a “clamp portion”, and the extending portions 73 and 73b, the recess 734, and the angle determining portion 736 are an example of a “third engagement portion”. The band attachment portion 84, the housing portion 844, the second restricting portion 842, and the first restricting portion 841 are an example of a “fourth engagement portion”. The base portion 730, the angle determining portion 736, and the recess 734 are an example of a “base portion”, an “angle determining portion” and an “engagement recess”. The housing portion 844 is an example of a “housing portion”, and the first restricting portion 841 and the second restricting portion 842 are an example of an “engagement protrusion”. The engagement protrusion 215 and the recess 717 are an example of a “fifth engagement portion”, a “protrusion”, and a “sixth engagement portion”. The first main body 711 and the second main body 712 are an example of a “first main body” and a “second main body”. The distance adjustment portion 75 is an example of a “distance adjustment portion”. The motor 53 and the spindle 51 are an example of a “motor” and a “spindle”.

Note that the attachments 200 and 200b, and the oscillating tools 100 and 100b according to the present disclosure are not limited to the attachments 200 and 200b, and the oscillating tools 100 and 100b according to the above-described embodiments. For example, changes exemplified below in a non-limiting manner are possible. Further, at least one of those changes can be adopted in combination with at least one of the attachments 200 and 200b, and the oscillating tools 100 and 100b according to the embodiments, and the features described in the claims.

### Other embodiments

(C1) In the above-described first embodiment, the example is shown in which the shaft portion 42 and the shaft fixing portion 82 include the ratchet mechanism that restricts the movement of the shaft portion 42 with respect to the shaft fixing portion 82 to being toward the fourth direction first side Q1. In contrast, the shaft portion 42 and the shaft fixing portion 82 need not necessarily include the ratchet mechanism. In other words, the lever 820 need not necessarily include the claw 826, and the shaft portion 42 need not necessarily include the teeth 421. In this case, for example, the shaft portion 42 can be fixed to the insertion portion 86 by the tip end of the lever 820 coming into contact with the shaft portion 42, and by utilizing a frictional force between the lever 820 and the shaft portion 42.

(C2) In the above-described first embodiment, the example is shown in which the shaft portion 42 has the square columnar shape. In contrast, the shaft portion 42 may be configured as a prismatic column other than the square column, such as a hexagonal column, a triangular column, or the like. In this case, the rotation angle to which the shaft portion 42 can be rotated around the long axis QX can be set in accordance with the cross-sectional shape thereof perpendicular to the long axis of the prismatic column. Further, the shaft portion 42 may have a circular columnar shape. By being configured in this way, the shaft portion 42 can be rotated around the long axis QX in a stepless manner.

(C3) In the above-described first embodiment, the example is shown in which the restricting member 40 and the coupling member 80 are the separate bodies. In contrast, for example, in a case in which the shaft portion 42 is not rotated around the long axis QX or the like, the restricting member 40 and the coupling member 80 may be integrally coupled.

(C4) In the above-described first embodiment, the example is shown in which the restricting surface 442 of the restricting member 40 has the rectangular shape. In contrast, the restricting surface 442 is not limited to being substantially rectangular and may have a desired geometric shape other than the rectangle, such as a square, a circle, or the like. The restricting surface 442 is not limited to being the flat surface, and, for example, can have a mode in which a flat surface that comes into contact with the object is substantially formed by having a tip end with three or more protrusions that can come into contact with the object.

(C5) In the above-described first embodiment, the example is described in which the motor 53 is disposed such that the rotation axis MX of the output shaft 531 of the motor 53 is orthogonal to the drive axis TX of the spindle 51. In contrast, the motor 53 may be disposed such that the rotation axis MX and the drive axis TX are parallel to each other. When the rotation axis MX is configured to be parallel to the drive axis TX, the front-rear direction of the oscillating tool 100 can be defined as the extending direction of the housing 2 (the direction corresponding to the long axis of the housing 2) instead of the rotation axis MX of the output shaft 531 of the motor 53. The extending direction and the long axis of the housing 2 can be defined by a center axis of the housing 2 or a center axis of the grip portion 252.

(C6) In the above-described first embodiment, the example is shown in which the plurality of teeth 421 are formed on each of the side surfaces around the long axis QX of the shaft portion 42. In contrast, in a case in which the shaft portion 42 is not rotated to the plurality of rotation angles around the long axis QX or the like, the plurality of teeth 421 may be formed only on any one of the side surfaces of the shaft portion 42 around the long axis QX.

(C7) In the above-described first embodiment, the case is shown in which the recess 734 of the extending portion 73 is formed over the whole periphery around the long axis PX of the base portion 730. In contrast, the recess 734 may be formed in only a part of the base portion 730. In this case, the first restricting portion 841 and the second restricting portion 842 can be configured by the claw 826 or a protruding portion that can engage with the recess 734.

In view of the present invention and the gist of the above-described embodiments, the following aspects are constructed. At least one of the following aspects can be adopted in combination with the features of the embodiments and modified examples thereof, or with at least one of the features disclosed in each of claims.

### Aspect 1

The first engagement portion of the shaft portion and the fixing portion of the coupling member include the ratchet mechanism that limits a movement direction of the shaft portion inserted into the insertion portion to being a first direction.

### Aspect 2

The attachment member includes

an attachment portion detachably attached to the power tool to surround the drive axis, and

a third engagement portion detachably attached to the attachment portion to extend from the attachment portion.

According to this aspect, the arrangement of the coupling member and the restricting member around the drive axis can be switched using a simple method of attaching and detaching the third engagement portion to and from the attachment portion attached to the oscillating tool. The attachment portion 74 is an example of the “attachment portion”, and the extending portion 73b and the base portion 730b are an example of the “third engagement portion”.

### Aspect 3

The attachment portion is configured to attach the third engagement portion at a plurality of rotation angles around the drive axis.

According to this aspect, the arrangement of the coupling member and the restricting member at a desired rotation angle around the drive axis can be switched using the simple method of attaching and detaching the third engagement portion to and from the attachment portion attached to the oscillating tool.

### Aspect 4

The attachment portion includes a main body having a cylindrical shape surrounding the drive axis, and

the third engagement portion is configured to be attached at positions, of the main body, that are the plurality of rotation angles.

According to this aspect, the arrangement of the coupling member and the restricting member at the desired rotation angle around the drive axis can be switched using the simple method of attaching and detaching the third engagement portion to and from the main body attached to the oscillating tool. The main body 740 is an example of the “main body”.

### Aspect 5

The third engagement portion includes:
(i) a plate extending in a direction orthogonal to the drive axis when the attachment portion is attached to the power tool,
(ii) a wall portion extending from the plate in a direction parallel to the drive axis, and
(iii) an engagement claw extending from the plate in a direction parallel to the drive axis and disposed facing the wall portion.

The attachment portion is disposed on the plate between the wall portion and the engagement claw, and

the engagement claw is configured to engage with a part of the attachment portion disposed between the wall portion and the engagement claw.

According to this aspect, the attachment portion and the third engagement portion can be coupled strongly to each other by the attachment portion being clamped on the plate between the wall portion and the engagement claw. Thus, it is possible to suppress or prevent the third engagement portion from falling off from the attachment portion. The plate 780, the wall portion 781, and the engagement claw 788 are an example of the “plate”, the “wall portion” and the “engagement claw”.

### Aspect 6

The attachment portion includes a plurality of guide portions that, when engaging the engagement claw with a part of the attachment portion, guide the engagement claw to the part of the attachment portion.

According to this aspect, a user can appropriately determine the position of the extending portion with respect to the main body using a simple method of determining the position of the engagement claw with the guide portion at a desired position. The plurality of guide portions 748 are an example of “the plurality of guide portions”.

### Aspect 7

The attachment portion includes a first engagement portion having a protruding shape or a recess shape, and

the third engagement portion includes a second engagement portion having a recess shape or a protruding shape that engages with the first engagement portion.

According to this aspect, movement of the third engagement with respect to the attachment portion can be restricted by a simple method of the engagement between the first engagement portion and the second engagement portion. The first engagement portion 741 is an example of the “first engagement portion”, and the second engagement portion 782 is an example of the “second engagement portion”.

### Aspect 8

The attachment portion includes a restriction portion that is engaged with the power tool, and that restricts the main body from moving with respect to the drive axis.

According to this aspect, the attachment can be strongly fixed to the power tool. The restricting portion 760 is an example of the “restricting portion”.

### Aspect 9

A metal shaft extending in the extending direction of the shaft portion is provided inside the shaft portion.

According to this aspect, compared to a case in which the shaft portion is formed from a metal material, it is possible to make the shaft portion lighter. The metal shaft 420 is an example of the “metal shaft”.

A correspondence between each of structural elements (features) of the above-described embodiments and each of structural elements (features) of the present disclosure or the present invention is as described below. Note that each of the structural elements of the embodiment is merely an example, and is not intended to limit each of the structural elements of the present disclosure or the present invention.

The present disclosure is not limited to the above-described embodiments, and can be realized by various configurations insofar as they do not depart from the gist and scope of the present disclosure. For example, technological features in the embodiments corresponding to technological features in each of modes listed in the Summary of the invention can be switched or combined as appropriate, in order to resolve some or all of the above-described problems, or in order to achieve some or all of the above-described effects. Further, those technological features can be omitted as appropriate insofar as they are not described as being essential in the present specification.

2, 2b Housing, 4 Controller, 5 Drive mechanism, 6 Lock mechanism, 21, 21b Front end portion, 23 Rear end portion, 25, 25b Central portion, 29 Switch, 38 Metal housing, 40, 40b Restricting member, 42, 42b Shaft portion, 44 Stopper portion, 44E Tip end, 51 Spindle, 52 Clamp shaft, 53 Motor, 55 Transmission mechanism, 61 Operation lever, 70, 70b Attachment member, 71 Clamp portion, 73, 73b Extending portion, 74 Attachment portion, 75 Distance adjustment portion, 80 Coupling member, 82 Shaft fixing portion, 84 Band attachment portion, 86 Insertion portion, 87 Dial, 88 Main body, 91 Tip tool, 93 Battery, 100, 100b Oscillating tool, 200, 200b Attachment, 212 Circular cylindrical portion, 215 Engagement protrusion, 216 Rectangular portion, 216A First housing portion, 216B Second housing portion, 218 Engagement recess, 252 Grip portion, 254, 254b Motor housing, 290 Switch knob, 291 Switch lever, 331 Battery attachment portion, 381 First section, 382 Second section, 420 Metal shaft, 421 Teeth, 421T Inclined portion, 442 Restricting surface, 511 Tool attachment portion, 521 Clamp head, 531 Output shaft, 551 Eccentric shaft, 552 Arm portion, 553 Coupling arm, 554 Annular portion, 555 Drive bearing, 711 First main body, 712 Second main body, 713 First protruding portion, 713H Through hole, 714 Second protruding portion, 714H Through hole, 715 Nut, 716 Protruding wall, 716W1 Inner surface, 716W2 Outer surface, 717 Recess, 730, 730b Base portion, 730R Recess, 734, 734b Recess, 735 Protrusion, 736 Angle determining portion, 737 Protrusion, 737R Recess, 738 Plate, 738B Surface, 740 Main body, 741 First engagement portion, 742 Shoulder portion, 748 Guide portion, 752 Dial, 754 Shaft portion, 760 Restricting portion, 763 Engagement claw, 764 Fourth engagement portion, 767 Base portion, 780 Plate, 781 Wall portion, 781R Recess, 782 Second engagement portion, 783 First elastic body, 784 Second elastic body, 787 Base portion, 788 Engagement claw, 789 Operation portion, 820 Lever, 822 Coil spring, 824 Shaft, 826 Claw, 826T Inclined portion, 841 First restricting portion, 842 Second restricting portion, 844 Housing portion, 844B Bottom portion, 844W1 Wall surface, 844W2 Wall surface, 881 First surface, 882 Second surface, 883 Third surface, 884 Fourth surface, 885 Fifth surface, 886 Sixth surface, 888 Restricting portion, MX Rotation axis, OB1 Object, OB2 Workpiece, OX Long axis, PX Long axis, QX Long axis, RX Long axis, TX drive axis

1. A power tool attachment used in a power tool that machines a workpiece by driving a tip tool to oscillate around a drive axis, the power tool attachment comprising:
an attachment member detachably attached to the power tool;
a restricting member configured to come into contact with an object and restrict relative movement of the power tool with respect to the object; and
a coupling member configured to couple the restricting member and the attachment member, wherein
the restricting member includes
(i) a shaft portion, and
(ii) a stopper portion coupled to a tip end of the shaft portion and having a restricting surface orthogonal to a long axis of the shaft portion, and
the coupling member is configured to couple the restricting member and the attachment member to each other to cause the power tool attachment to be in a first state, the first state being a state in which the long axis of the shaft portion and the drive axis of the tip tool are parallel to each other when the attachment member is attached to the power tool.

2. The power tool attachment according to claim 1, wherein
the coupling member includes
(i) an insertion portion, the shaft portion being insertable into the insertion portion, and
(ii) a fixing portion configured to come into contact with the shaft portion inserted into the insertion portion and to fix the shaft portion,
the fixing portion is configured to come into contact at a plurality of positions of the shaft portion in an extending direction of the shaft portion, and
the coupling member is configured for a distance from the coupling member to the stopper portion in the extending direction of the shaft portion to be adjustable by switching the position at which the fixing portion comes into contact with the shaft portion.

3. The power tool attachment according to claim 2, wherein
the shaft portion includes a plurality of first engagement portions formed at a plurality of positions in the extending direction of the shaft portion,
the fixing portion includes a second engagement portion engageable with each of the plurality of first engagement portions, and
the coupling member is configured for the distance from the coupling member to the stopper portion in the extending direction of the shaft portion to be adjustable using the engagement between the second engagement portion and the plurality of first engagement portions.

4. The power tool attachment according to claim 3, wherein
the first engagement portions of the shaft portion and the fixing portion of the coupling member include a ratchet mechanism that limits a movement direction of the shaft portion inserted into the insertion portion to a first direction.

5. The power tool attachment according to claim 2, wherein
the insertion portion is configured for the shaft portion to be insertable therein in a state of the shaft portion being rotated to a plurality of rotation angles around the long axis of the shaft portion.

6. The power tool attachment according to claim 1, wherein
the attachment member includes
a clamp portion to be attached to the power tool to surround the drive axis, and
a third engagement portion extending from the clamp portion,
the coupling member includes
a fourth engagement portion engageable with the third engagement portion that is in a state of being rotated to a plurality of rotation angles around a long axis of the third engagement portion, and
using the engagement between the third engagement portion and the fourth engagement portion, the coupling member is configured to couple, to the attachment member, the restricting member rotated to the plurality of rotation angles around the long axis of the third engagement portion.

7. The power tool attachment according to claim 6, wherein
using the engagement between the third engagement portion and the fourth engagement portion, the coupling member is configured to switch the power tool attachment between (i) the first state, and (ii) a second state in which, when the attachment member is attached to the power tool, the long axis of the shaft portion is orthogonal to the drive axis of the tip tool and to an extending direction of the third engagement portion.

8. The power tool attachment according to claim 7, wherein
the third engagement portion includes
(i) a base portion extending from the clamp portion,
(ii) an angle determining portion coupled to a tip end of the base portion, and
(iii) an engagement recess formed in the base portion, and
the fourth engagement portion includes
(i) a housing portion able to house the angle determining portion rotated to a plurality of rotation angles around a long axis of the base portion, and
(ii) an engagement protrusion configured to engage with the engagement recess and fix the angle determining portion housed in the housing portion.

9. The power tool attachment according to claim 1, wherein
the attachment member includes a clamp portion to be attached to the power tool to surround the drive axis, and
the clamp portion is configured to attach, to the power tool, the attachment member rotated to a plurality of rotation angles around the drive axis.

10. The power tool attachment according to claim 9, wherein
the clamp portion includes a plurality of sixth engagement portions engageable with a fifth engagement portion formed in the power tool,
the plurality of sixth engagement portions are formed at a plurality of positions corresponding to the plurality of rotation angles around the drive axis, and
the clamp portion is configured to attach, to the power tool, the attachment member rotated to the plurality of rotation angles around the drive axis, by engaging the fifth engagement portion with one of the plurality of sixth engagement portions formed at the plurality of positions.

11. The power tool attachment according to claim 10, wherein
the clamp portion includes a first main body and a second main body disposed facing each other and clamp the power tool to surround the drive axis, and
the attachment member includes a distance adjustment portion configured to adjust a separation distance between the first main body and the second main body.

12. The power tool attachment according to claim 11, wherein
the fifth engagement portion is a protrusion protruding from an outer surface of the power tool by a predetermined distance, and
the attachment member is configured to adjust the separation distance by an amount equal to or greater than the distance by which the protrusion protrudes from the outer surface of the power tool.

13. The power tool attachment according to claim 6, wherein
the clamp portion is configured to attach, to the power tool, the attachment member rotated to a plurality of rotation angles around the drive axis.

14. The power tool attachment according to claim 13, wherein
the coupling member includes
(i) an insertion portion, the shaft portion being insertable into the insertion portion, and
(ii) a fixing portion configured to come into contact with the shaft portion inserted into the insertion portion and to fix the shaft portion,
the fixing portion is configured to come into contact at a plurality of positions of the shaft portion in an extending direction of the shaft portion, and
the coupling member is configured for a distance from the coupling member to the stopper portion in the extending direction of the shaft portion to be adjustable by switching the position at which the fixing portion comes into contact with the shaft portion.

15. A power tool that machines a workpiece by driving a tip tool to oscillate around a drive axis, the power tool comprising:
a motor;
a spindle configured to use power from the motor to drive the tip tool to oscillate around the drive axis; and
the power tool attachment according to claim 1.
